(19) United States
(12) Patent Application Publication
(10) Pub. No.: US 2005/0043948 A1
(43) Pub. Date: Feb. 24, 2005

(54) Speech recognition method remote controller, information terminal, telephone communication terminal and speech recognizer

(76) Inventors: Seiichi Kashihara, Kanagawa (JP); Hideyuki Yamagishi, Tokyo (JP); Katsumasa Nagahama, Kanagawa (JP); Tadasu Oishi, Kanagawa (JP)

Correspondence Address: FINNEGAN, HENDERSON, FARABOW, GARRETT & DUNNER;LLP, 1300 I STREET, NW, WASHINGTON, DC, 20005, US

(21) Appl. No.: 10/499,220

(22) PCT Filed: Dec. 17, 2002
(86) PCT No.: PCT/JP02/13182

(30) Foreign Application Priority Data
Dec. 17, 2001 (JP) 2001-382613
Apr. 19, 2002 (JP) 2001-117964

(51) Int. Cl. G10L 15/00

(52) U.S. Cl. 704/242

(57) ABSTRACT

A speech recognition method can be preferably applied to equipment for constantly performing speech recognition, converts speech into an acoustic parameter series, calculates for the acoustic parameter series the likelihood of a hidden Markov model 22 corresponding to the speech unit label series about a registered word and the likelihood of a virtual model 23 corresponding to the speech unit label series for recognition of speech other than the registered word, and performs speech recognition based on the likelihoods.

### TECHNICAL FIELD

The present invention relates to a speech recognition method for controlling by speech an equipment unit available in a common living environment, a remote controller, an information terminal, a telephone communication terminal, and a speech recognizer using the speech recognition method.

### BACKGROUND ART

In a conventional remote controller, an equipment unit requires one remote controller, and it is common that the same remote controller cannot remotely control different equipment units. For example, a remote controller for a television cannot remotely control an air-conditioner. A remote controller is provided with a number of switches depending on the operation contents to be controlled, and a control signal for a target equipment unit is selected based on the press status of the switches and transmitted to the target equipment unit. In the case of a video tape recorder, etc., there are a number of necessary operation buttons such as a button for selection of a desired television station, a button for designation of a time for reservation of a program, a button for setting the running status of a recording tape, etc., and the operations of the buttons are complicated. Furthermore, since a remote controller is required for each target equipment unit, the user has to correctly understand the correspondence between each remote controller and its target equipment unit, which has been a very laborious operation.

A remote controller which aims at eliminating the above-mentioned large number of switches and controlling the operations of a plurality of target equipment units using only one remote controller has been disclosed by, for example, Japanese Patent Laid-Open No. 2-171098. In the prior art, the remotely controlled contents are specified by speech input, and a control signal is generated based on a speech recognition result. The speech recognition remote controller of the prior art has a rewritable map for use in converting a speech recognition result into an equipment control code so that a plurality of target equipment units can be operated, and the contents of the map are rewritten depending on the equipment unit to be operated. The map rewriting operation requires changing an IC card storing the map of conversion codes for each target equipment unit. When a target equipment unit is changed, a corresponding IC card is to be searched for.

In the speech recognition remote controller described in Japanese Patent Laid-Open No. 5-7385, a prohibition flag is stored for the operation contents to be prohibited when they are generated based on the operation status of the equipment unit in the equipment status memory using a correspondence table between equipment and word, and a correspondence table between control signal and equipment status.

However, when a plurality of equipment units are controlled by a single remote controller in the speech recognition technology, the number of words to be recognized increases. Therefore, the contents of input speech are not always correctly recognized, that is, recognized as different contents from the designated contents, thereby causing a malfunction and reducing the features of the remote controller as a convenient unit. Particularly, when an acoustic equipment unit such as a television, an audio device, etc., noise generated by a target equipment unit can start a speech recognizing process, the equipment unit can be operated without utterance of the user, or the utterance correctly referring to desired control contents can be misrecognized due to the noise generated by the acoustic equipment, thereby requiring repeated utterance many times.

For the speech recognition remote controller for controlling the above-mentioned acoustic equipment, Japanese Patent Laid-Open No. 57-208596 discloses means for improving the recognition rate of a speech recognition circuit by muting the audio means of a television receiver, etc. when the utterance of the speech of a user is detected. Japanese Patent Laid-Open No. 10-282993 discloses the technology of improving the detection of a speech command by enhancing the immunity to the error in a speech recognizing process by providing a sound compensator used in correcting a microphone signal with an audio signal transmitted by an audio equipment unit evaluated in the position of the speech input device by modeling a transmission line in a space between a speaker and a microphone using a speech command input from a speech input device and a signal formed by an audio signal and other signals of background noise. In this case, when the speech recognition remote controller is used, a special circuit is to be provided for an instruction to perform a muting process for a target equipment unit in advance, and special knowledge such as adjusting the position and sensitivity of a microphone, etc. is required. Therefore, there have been a problem for a general-purpose device.

Furthermore, with the speech recognition remote controller according to the above-mentioned conventional technology, and with an increasing number of target equipment units to be controlled, there can be a malfunction due to the misrecognition by an unknown word, an unnecessary word, and the utterance beyond the prediction of the system, etc. Therefore, to realize a speech recognition remote controller of a more convenient speech recognition type, the rejecting capability of determining an incorrect recognition result and the utterance beyond the prediction of the system is demanded. Especially, in the status in which a speech recognizing process is constantly performed, the noise caused on normal living conditions in a use environment, for example, the conversation among friends, the sound of the steps of the person walking near the remote controller, the utterance of pets, the noise made in the cooking operation in the kitchen, etc. cannot be eliminated by the current speech recognition technology. As a result, there has been the problem that misrecognition occurs frequently. If the allowance range of the matching determination with a registered word is strictly set to reduce the misrecognition, the misrecognition can actually be reduced, but a target word to be recognized can also be rejected frequently, thereby requiring repeated utterance and constituting a nuisance for a user.

The above-mentioned problem is not limited to the remote controller, but various speech recognition devices such as an information terminal, a telephone communication terminal, etc. have similar problems.

The present invention has been developed to solve the above-mentioned problems with the conventional technology, and aims at providing a speech recognition method applicable to equipment for constantly performing speech recognition with the misrecognition by noise caused on normal living conditions reduced, a remote controller, an information terminal, a telephone communication terminal, and a speech recognizer using the speech recognition method.

### DISCLOSURE OF INVENTION

To solve the above-mentioned problems, the present invention includes the following configuration. That is, the speech recognition method according to the present invention performs speech recognition by converting input speech of a target person whose speech is to be recognized into an acoustic parameter series, and comparing using a Viterbi algorithm the acoustic parameter series with the acoustic model corresponding to the speech unit label series about a registered word, provides parallel to a speech unit label series for the registered word a speech unit label series for recognition of an unnecessary word other than a registered word, and calculates also the likelihood of the speech unit label series for an unnecessary word other than the registered word in the comparing process using the Viterbi algorithm, thereby successfully recognizing the unnecessary word as an unnecessary word when it is input as input speech. That is, the speech is converted into an acoustic parameter series for which the likelihood of the acoustic model for recognizing a registered word corresponding to the speech unit label series about the registered word and the likelihood of the acoustic model for recognizing an unnecessary word corresponding to the speech unit label series for recognition of the speech other than the registered word are calculated. Based on the likelihoods, the speech recognition is conducted.

With the above-mentioned configuration, if noise caused on normal living conditions, etc. containing no registered words, that is, the speech other than a registered word, is converted into an acoustic parameter series, then the likelihood of the acoustic model corresponding to the speech unit label series about the registered word is calculated with a small resultant value output while the likelihood of the acoustic model corresponding to the speech unit label series about the unnecessary word is calculated with a large resultant value output. Based on these likelihoods, the speech other than the registered word can be recognized as an unnecessary word, thereby preventing the speech other than the registered word from being misrecognized as a registered word.

The acoustic model corresponding to the speech unit label series can be an acoustic model using a hidden Markov model, and the speech unit label series for recognition of the unnecessary word can be a virtual speech unit model obtained by equalizing all available speech unit models. That is, the acoustic model for recognizing an unnecessary word can be converged into a virtual speech unit model obtained by equalizing all speech unit models.

With the above-mentioned configuration, when the speech containing a registered word is converted into an acoustic parameter series, the likelihood of the hidden Markov model corresponding to the speech unit label series about a registered word is calculated as larger than the likelihood of the virtual speech unit model obtained by equalizing all speech unit models for the acoustic parameter series. Based on the likelihoods, a registered word contained in the speech can be recognized. When noise caused on normal living conditions, etc. containing no registered words, that is, the speech other than a registered word, is converted into an acoustic parameter series, for the acoustic parameter series, the likelihood of a virtual speech unit model obtained by equalizing all speech unit models is calculated as larger than the likelihood of the hidden Markov model corresponding to the speech unit label series about a registered word. Based on the likelihoods, the speech other than the registered word can be recognized as an unnecessary word, thereby preventing the speech other than the registered word from being misrecognized as a registered word.

The acoustic model corresponding to the speech unit label series can be an acoustic model using a hidden Markov model, and the speech unit label series for recognition of the unnecessary word can have a self-loop network formed by phonemes of vowels only. That is, the acoustic model for recognizing an unnecessary word can be a group of phoneme models corresponding to the phonemes of vowels, has a self-loop from the end point of the group to the starting point, calculates for the acoustic parameter series the likelihood of the phoneme model group corresponding to the phonemes of vowels, and the maximum value is accumulated to determine the likelihood of an unnecessary word model.

With the above-mentioned configuration, when the speech containing a registered word is converted into an acoustic parameter series, depending on the existence of the phoneme of the consonant contained in the acoustic parameter series, for the acoustic parameter series, the likelihood of the hidden Markov model corresponding to the speech unit label series about a registered word is calculated as larger than the likelihood of the self-loop network configured by the phonemes of vowels only. Based on the likelihood, the registered word contained in the speech can be recognized. When the noise caused on normal living conditions, etc., that is, the speech containing no registered words, that is, the speech other than a registered word, is converted into an acoustic parameter series, depending on the phoneme of a vowel contained in the acoustic parameter series and not contained in a registered word, the likelihood of the self-loop network configuration of the phoneme of vowels only is calculated as larger than the likelihood of the memory corresponding to the speech unit label series about a registered word for the acoustic parameter. Based on the likelihood, the speech other than the registered word can be recognized as an unnecessary word, and the speech other than the registered word can be prevented from being misrecognized as a registered word.

On the other hand, to solve the above-mentioned problem, the remote controller according to the present invention can remotely control by speech a plurality of operation targets, and includes: storage means for storing a word to be recognized indicating a remote operation; means for inputting speech uttered by a user; speech recognition means for recognizing the word to be recognized and contained in the speech uttered by the user using the storage means; and transmission means for transmitting an equipment control signal corresponding to a word to be recognized and actually recognized by the speech recognition means, and the speech recognition method is based on the speech recognition method according to any of claims 1 to 3. That is, the remote controller includes: speech detection means for detecting the speech of a user; speech recognition means for recognizing a registered word contained in the speech detected by the speech detection means; and transmission means for transmitting an equipment control signal corresponding to the registered word recognized by the speech recognition means. The speech recognition means recognizes a registered word contained in the speech detected by the speech detection means in the speech recognition method according to any of claims 1 to 3.

With the above-mentioned configuration, when the noise caused on normal living conditions, etc. which is speech containing no registered words, that is, speech other than a registered word, is uttered by a user, the likelihood of an acoustic model corresponding to the speech unit label series about an unnecessary word is calculated with a large resultant value output for the acoustic parameter series of the speech while the likelihood of the acoustic model corresponding to the speech unit label series about the registered word is calculated with a small resultant value output. Based on the likelihoods, the speech other than the registered word can be recognized as an unnecessary word, the speech other than the registered word can be prevented from being misrecognized as a registered word, and a malfunction of the remote controller can be avoided.

The remote controller also includes a speech input unit for allowing a user to perform communications, and a communications unit for controlling the setting state to the communications line based on the word to be recognized by the speech recognition means, and the speech input means and the speech input unit of the communications unit can be separately provided.

With the above-mentioned configuration, although a user is communicating with a partner and the communications occupy the speech input unit of the communications unit, the speech of the user can be input to the speech recognition means and the communications unit can be controlled.

The remote controller can also include control means for performing at least one of a process of transmitting and receiving mail by speech, a process of managing a schedule by speech, the memo processing by speech, and a notifying process by speech.

With the above-mentioned configuration, a user can perform the process of transmitting and receiving mail by speech, the process of managing a schedule by speech, the memo processing by speech, and the notifying process by speech by only uttering a registered word without any physical operation.

To solve the above-mentioned problem, the information terminal according to the present invention includes: speech detection means for detecting the speech of a user; speech recognition means for recognizing a registered word contained in the speech detected by the speech detection means; and control means for performing at least one of the speech recognizing process, the process of managing a schedule by speech, the memo processing by speech, and the notifying process by speech. The speech recognition means can recognize a registered word contained in the speech detected by the speech detection means in the speech recognition method according to any of claims 1 to 3. The process of transmitting and receiving mail by speech can be performed by, for example, a user inputting by speech the contents of mail, converting the speech into speech data, transmitting the speech data by attaching it to electronic mail, receiving the electronic mail to which the speech data is attached, and regenerating the speech data. The process of managing a schedule by speech can be performed by, for example, a user input by speech the contents of a schedule, converting the speech into speech data, inputting the execution day of the schedule, and managing the schedule with the speech data associated with the execution day. The memo processing by speech can be performed by, for example, a user input by speech the contents of a memo, converting the speech into speech data, and regenerating speech data at a request of the user. The notifying process by speech can be performed by, for example, a user inputting the contents of a notice, converting the speech into speech data, inputting a notice timing, and regenerating the speech data at the notice timing.

With the configuration, when noise caused on normal living conditions, etc. that is, speech containing no registered words, that is, speech other than a registered word, is uttered by a user, the likelihood of the acoustic model corresponding to the speech unit label series about an unnecessary word is calculated as larger than the acoustic parameter series of the speech while the likelihood of the acoustic model corresponding to the speech unit label series about the registered word is calculated as smaller. Based on the likelihoods the speech other than the registered word can be recognized as an unnecessary word, thereby preventing the speech other than the registered word from being misrecognized as a registered word, and suppressing a malfunction of an information terminal. Furthermore, the user can perform the process of transmitting and receiving mail by speech, the process of managing a schedule by speech, the memo processing by speech, and the notifying process by speech only by uttering a registered word without a physical operation.

On the other hand, to solve the above-mentioned problem, the telephone communication terminal according to the present invention can be connected to a public telephone line network or an Internet communications network, and includes: speech input/output means for inputting and outputting speech; speech recognition means for recognizing input speech; storage means for storing personal information including the name and phone number of a communication partner, screen display means; and control means for controlling each means. The speech input/output means has the respective and independent input/output systems in the communications unit and the speech recognition unit. That is, the terminal includes speech input unit for allowing a user to input by speech a registered word relating to a telephone operation; a speech recognition unit for recognizing the registered word input through the speech input unit, and a communications unit, having a speech input unit for allowing a user to perform communications, for controlling the connection status to a communications line according to the registered word recognized by the speech recognition unit. The speech input unit of the speech recognition unit and the speech input unit of the communications unit are individually provided.

With the above-mentioned configuration, although a user is communicating with a partner and the communications occupy the input/output system of the communications unit, the speech of the user can be input to the speech recognition unit, and the communications unit can be controlled.

Additionally, to solve the above-mentioned problem, the telephone communication terminal according to the present invention can be connected to a public telephone line network or an Internet communications network, and includes: speech input/output means for inputting and outputting speech; speech recognition means for recognizing input speech; storage means for storing personal information including the name and phone number of a communication partner; screen display means; and control means for controlling each means. The storage means separately stores a name vocabulary list of specific names including the name of a person registered in advance; a number vocabulary list of arbitrary phone numbers; a telephone call operation vocabulary list of telephone operations during communications; and a call receiving operation vocabulary list of telephone operations for an incoming call. All telephone operations relating to an outgoing call, a disconnection, and an incoming call can be performed by the speech recognition means, the storage means, and the control means by input of speech. That is, the storage means individually stores a name vocabulary list in which specific names are registered, a number vocabulary list in which arbitrary phone numbers are registered, a telephone call operation vocabulary list in which words related to telephone operations during the communications are registered, and a call receiving operation vocabulary list in which words related to telephone operations are registered when an incoming call is received. The speech recognition means selects a vocabulary list stored in the storage means depending on the recognition result by the speech recognition means or the status of the communications line, refers to the vocabulary list, and recognizes the word contained in the speech input through the speech input/output means.

With the above-mentioned configuration, the vocabulary list can be changed into an appropriate list depending on the situation, thereby preventing an occurrence of misrecognition by noise caused on normal living conditions, etc. which is unnecessary speech.

The method of recognizing a phone number can also be realized by recognizing a number string pattern formed by a predetermined number of digits or symbols using a number vocabulary list of the storage means and the phone number vocabulary network for recognition of an arbitrary phone number by the speech recognition method by inputting all number of digits of continuous utterance. That is, the storage means stores a serial number vocabulary list in which number strings corresponding to all digits of phone numbers are registered, and the speech recognition means can refer to the serial number vocabulary list stored in the storage means when a phone number contained in the input speech is recognized.

With the above-mentioned configuration, when a phone number is to be recognized, the user only has to continuously utter a number string corresponding to the entire digits of the phone number, thereby recognizing the phone number in a short time.

The screen display means can have the utterance timing display function of announcing an utterance timing. That is, it can be announced that the speech recognition means in the status of possibly recognizing a registered word.

With the configuration, by uttering a word with an utterance timing announced by the screen display means, a user can utter a registered word with an appropriate timing, thereby appropriately recognizing the registered word.

Second control means for performing at least one of the process of transmitting and receiving mail by speech, the process of managing a schedule by speech, the memo processing by speech, and the notifying process by speech can be provided based on the input speech recognized by the speech recognition means.

With the configuration, a user can perform the process of transmitting and receiving mail by speech, the process of managing a schedule by speech, the memo processing by speech, and the notifying process by speech only by uttering a registered word without a physical operation.

The speech recognition means can recognize a registered word contained in input speech in the speech recognition method according to any of claims 1, 2, and 3.

With the above-mentioned configuration, when a user utters noise caused on normal living conditions, etc. containing no registered words, that is, speech other than a registered word, the likelihood of an acoustic model corresponding to the speech unit label series about an unnecessary word is calculated as a large value for the acoustic parameter series of the speech while the likelihood of the acoustic model corresponding to the speech unit label series about a registered word is calculated as a small value. Based on the likelihoods, the speech other than the registered word is recognized as an unnecessary word, thereby preventing the speech other than the registered word from being misrecognized as a registered word, and avoiding a malfunction of the telephone communication terminal.

On the other hand, to solve the above-mentioned problem, the speech recognizer according to the present invention includes: speech detection means for detecting the speech of a user; speech recognition means for recognizing a registered word contained in the speech detected by the speech detection means; and utterance timing notice means for announcing that the speech detection means is in a status in which the means can recognize a registered word.

With the above-mentioned configuration, by uttering speech when the status of recognizing a registered word is announced, a user can utter a registered word with an appropriate timing, thereby easily recognizing a registered word.

Volume notice means for announcing the volume of speech detected by the speech detection means can also be provided.

With the above-mentioned, a user can be helped in uttering a word at an appropriate volume, thereby easily recognizing a registered word.

### BRIEF DESCRIPTION OF DRAWINGS

FIG. 1 is a block diagram of the remote controller according to the first embodiment of the present invention;

FIG. 2 shows a rough configuration of the remote controller shown in FIG. 1;

FIG. 3 is a flowchart of the arithmetic process performed by the remote controller shown in 2;

FIG. 4 is an explanatory view of an image displayed on the LCD display device in the arithmetic process shown in FIG. 3;

FIG. 5 is an explanatory view of a speech recognizing process performed in the arithmetic process shown in FIG. 3;

FIG. 6 is an explanatory view of a vocabulary network used in the speech recognizing process shown in FIG. 5;

FIG. 7 is an explanatory view of a vocabulary network in which the unnecessary word model shown in FIG. 6 is a virtual phoneme model obtained by equalizing all phoneme models;

FIG. 8 is an explanatory view of a vocabulary network in which the unnecessary word model shown in FIG. 6 is a self-loop phonemes forming vowels;

FIG. 9 is an explanatory view of a vocabulary network in which the unnecessary word model shown in FIG. 6 is a combination of a virtual phoneme model obtain by equalizing all phoneme models and a self-loop phonemes forming vowels;

FIG. 10 is an explanatory view of a vocabulary network in which the unnecessary word model shown in FIG. 6 is a group of phonemes forming vowels;

FIG. 11 is an explanatory view of a vocabulary network without an unnecessary word model;

FIG. 12 is a block diagram of the information terminal according to the second embodiment of the present invention;

FIG. 13 shows a rough configuration of the information terminal shown in FIG. 12;

FIG. 14 is a flowchart of the arithmetic process performed by the information terminal shown in FIG. 13;

FIG. 15 is an explanatory view of an image displayed on the LCD display device in the arithmetic process shown in FIG. 14;

FIG. 16 is a flowchart of the arithmetic process performed by the information terminal shown in FIG. 13;

FIG. 17 is a flowchart of the arithmetic process performed by the information terminal shown in FIG. 13;

FIG. 18 is an explanatory view of an image displayed on the LCD display device in the arithmetic process shown in FIG. 17;

FIG. 19 is an explanatory view of an image displayed on the LCD display device in the arithmetic process shown in FIG. 17;

FIG. 20 is a flowchart of the arithmetic process performed by the information terminal shown in FIG. 13;

FIG. 21 is an explanatory view of an image displayed on the LCD display device in the arithmetic process shown in FIG. 20;

FIG. 22 is a flowchart of the arithmetic process performed by the information terminal shown in FIG. 13;

FIG. 23 is a block diagram of a telephone communication terminal having a speech recognizing function according to the third embodiment of the present invention;

FIG. 24 is a block diagram of a telephone communication terminal having a speech recognizing function as a variation of the third embodiment of the present invention;

FIG. 25 is a flowchart of the arithmetic process performed by the central control circuit shown in FIG. 23;

FIG. 26 is an explanatory view of an image displayed on the LCD display device in the arithmetic process shown in FIG. 25;

FIG. 27 is a flowchart of the arithmetic process performed by the central control circuit shown in FIG. 23;

FIG. 28 is an explanatory view of an image displayed on the LCD display device in the arithmetic process shown in FIG. 27;

FIG. 29 is a flowchart of the arithmetic process performed by the central control circuit shown in FIG. 23; and

FIG. 30 is a flowchart of the arithmetic process performed by the central control circuit shown in FIG. 23.

### BEST MODE FOR CARRYING OUT THE INVENTION

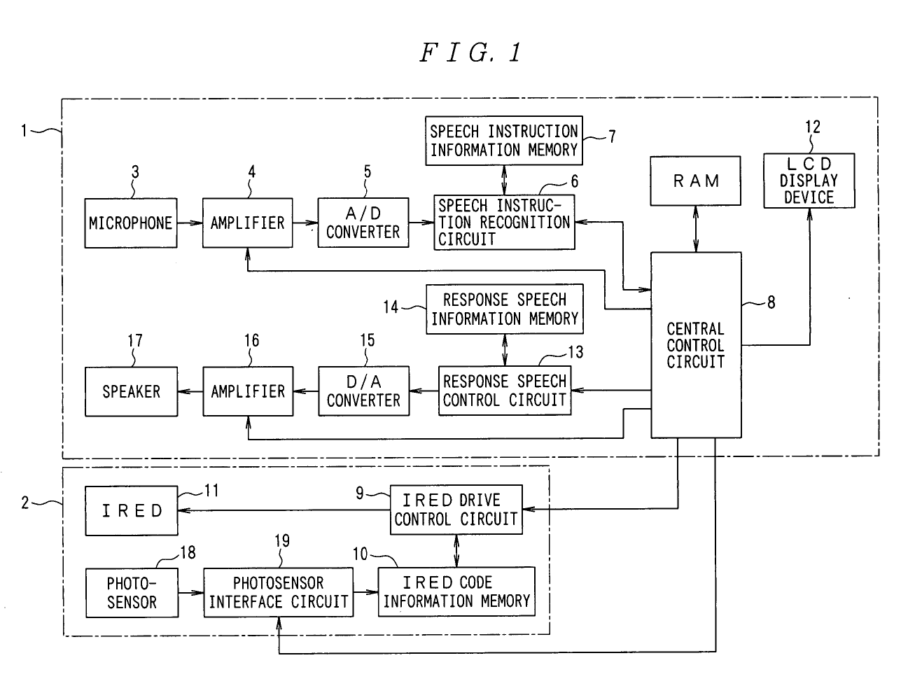

The embodiments of the present invention are described below by referring to the attached drawings. FIG. 1 is a primary block diagram of the remote controller according to the first embodiment of the present invention. The remote controller shown in FIG. 1 comprises the body of the remote controller for recognition of the speech of a user, that is, a remote controller body 1, and an infrared emitting unit 2 for issuing a control signal as an infrared signal based on the recognition result. The speech of the user is input from the speech input device (microphone 3) of the remote controller body 1, transmitted through an amplifier 4, and converted by an A/D converter 5 into a digitized acoustic parameter (for example, a spectrum, etc.). The input analog speech is not designated, but is normally sampled and digitized at a specific frequency in the range from 8 KHz to 16 KHz. The likelihood of the digitized acoustic parameter is calculated relative to the acoustic parameter for each speech unit which is a configuration unit of each word for the registered vocabulary list stored and registered in speech instruction information memory 7, in a speech instruction recognition circuit 6, thereby extracting the most likely word from the registered vocabulary list. That is, in the speech instruction recognition circuit 6, the likelihood of a word (hereinafter referred to as a registered word) in the registered vocabulary list and stored and registered in the speech instruction information memory 7 for the digitized acoustic parameter is calculated for each configuration unit (hereinafter referred to as a speech unit) in the speech instruction recognition circuit 6, and the largest accumulation value of the likelihood is extracted as the registered word closest to the speech of the user. In the speech instruction recognition circuit 6, the likelihood of the unnecessary word model stored and registered in the speech instruction information memory 7 is simultaneously calculated for the digitized acoustic parameter. When the likelihood of the unnecessary word model is higher than the likelihood of the registered word, it is assumed that no registered word has been extracted from the digitized acoustic parameter.

A speech unit can be a syllable, a phoneme, a semisyllable, a diphone (two pairs of phoneme), a triphone (three pairs of phoneme), etc., but described below is the case in which a phoneme is used as a speech unit for easier explanation.

In the speech instruction information memory 7, a control code corresponding to each registered word is stored, the control code corresponding to a registered word extracted by the speech instruction recognition circuit 6, that is, recognized by speech, is called from the speech instruction information memory 7, and transmitted through a central control circuit 8 to an IRED drive control circuit 9 of the infrared emitting unit 2. The IRED drive control circuit 9 calls an IRED code corresponding to the control code from an IRED code information memory 10, and issues it as an infrared signal from an IRED 11.

At this time, means for simultaneously notifying a user of a speech recognition result visually announces a recognition result by displaying it on an LCD display device 12, transmits the recognition result to a response speech control circuit 13, calls response speech data corresponding to the recognition result from a response speech information memory 14, and audially notifies a user from a speaker 17 as an analog speech through a D/A converter 15 and an amplifier 16.

The infrared emitting unit 2 is provided with a photosensor 18, and when it is necessary to use an infrared code not registered in the IRED code information memory 10, the infrared code can be added to the IRED code information memory 10 through a photosensor interface circuit 19 by issuing an infrared code to be used to the photosensor 18.

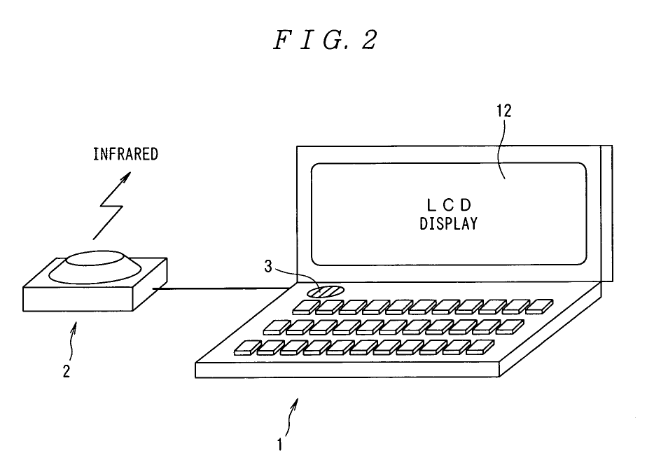

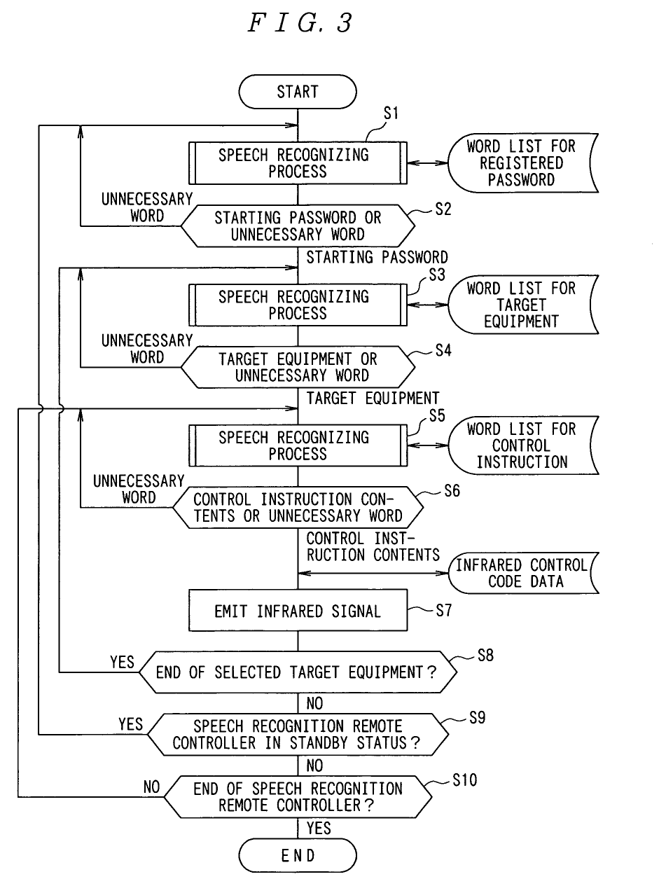

The hardware to be used is not specifically limited if it has the basic function as shown in FIG. 1. In the descriptions below, a generally marketed personal computer used as the remote controller body 1 as shown in FIG. 2 is explained. FIG. 3 is a flowchart of the arithmetic process performed by the speech recognition remote controller shown in FIG. 2, and transmitting an infrared code depending on the speech of a user. In the flowchart, a step for communications is not set, but the information obtained in the arithmetic process is updated and stored in the storage device, and necessary information is read from the storage device at any time. The arithmetic process is a process performed when the remote controller is started. In step S1, the speech detected by the microphone 3 is read, and the speech recognizing process of recognizing as described later whether the speech contains a starting password as a registered word, or the noise and speech other than the starting password, that is, an unnecessary word only, is performed. That is, by inputting by speech a starting password, it is notified that a person who wants to operate the remote controller is at the remote controller. A starting password can be arbitrarily set in advance using a user favorite word, the speech of the user, etc. However, when the speech recognition function is constantly operated, it is necessary to protect the remote controller against a malfunction due to the noise caused on normal living conditions read by the microphone 3. Therefore, a word not generally used, etc. is preferable. It is desired that a word having three or more, and less than 20 syllables is used. Furthermore, it is desired that a word configured by five or more and fifteen and less syllables is used. For example, a word such as “open sesame”, etc. is acceptable.

Then, in step S2, it is determined whether or not it has been recognized in step S1 that the starting password is contained in the speech. If the starting password is contained (YES), then control is passed to step S3, otherwise (if NO), control is passed to step S1 again. Therefore, if a word other than a starting password, that is, only noise and speech containing no starting password are input from the microphone 3, they are recognized as unnecessary words, and it is assumed that there is no user around, and the system enters a status in which input speech is awaited.

In step S3, the speech detected by the microphone 3 is read, and the speech recognizing process of recognizing as described later whether the speech contains the name of target equipment as a registered word, or the noise and speech other than the name of the target equipment, that is, an unnecessary word only, is performed. There are words (registered words) for selection of equipment and function such as target equipment can be a “TV”, a “video”, an “air-con”, an “audio”, a “light”, a “curtain”, a “telephone”, a “timer”, an “electronic mail”, a “speech memo”, etc. If a word other than a registered word, that is, if only words or noise not containing registered words are input, they are recognized as unnecessary words, and the system enters a status in which the name of new target equipment is awaited.

In step S4, it is determined whether or not the name of target equipment is contained in the speech. If the name of target equipment is contained (YES), then control is passed to step S6. Otherwise, (NO), control is passed to step S3 again. Therefore, if it is recognized that the speech detected by the microphone 3 contains a starting password, a mode in which a user selects target equipment is entered, and the system enters a status in which speech input is awaited until the name of target equipment, etc. is input. If no registered word to be recognized is input by speech although a predetermined time has passed, control is returned to the mode in which a starting pass word is recognized (steps S1 and S2) (not shown in FIG. 3), and the system enters a status in which speech input is awaited until a starting password is input, that is, a standby status.

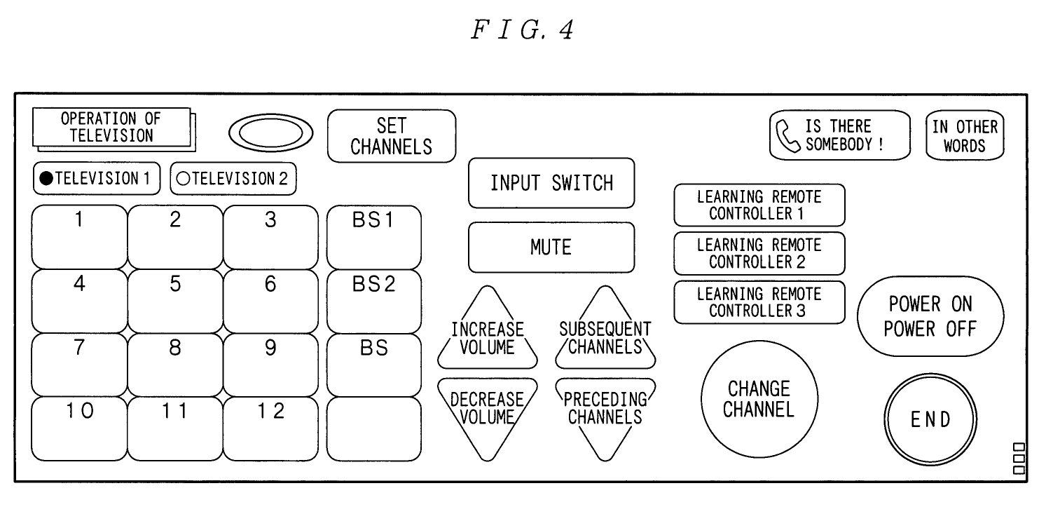

In step S6, the speech detected by the microphone 3 is read, and the speech recognizing process of recognizing, as described later, whether the speech contains the instruction contents for target equipment as a registered word, or the noise and speech other than the instruction contents for target equipment, that is, an unnecessary word only, is performed. That is, when the user selects target equipment, a mode in which the instruction contents of the target equipment can be controlled is entered. For example, when a “TV” is selected as target equipment, an image about the operations of television is displayed on the LCD display device 12 as shown in FIG. 4, and a mode in which a power on/off operation, selection of a channel number, selection of a broadcasting station, adjustment of volume, etc. can be specified is entered.

Then, in step S7, it is determined whether or not it has been recognized in step S6 that the instruction contents of the target equipment have been contained in the speech. If the instruction contents of the target equipment are contained (YES), then control is passed to step S8. Otherwise (NO), control is passed to step S6 again. That is, the system enters a status in which input of controllable instruction contents is awaited.

Then, in step S8, the infrared code corresponding to the instruction contents recognized in step S6 is transmitted to the infrared emitting unit 2. That is, when the instruction contents are input by speech, a corresponding infrared code is called based on the recognition result of the instruction contents, and the infrared code is transmitted from the infrared emitting unit 2 to the target equipment. In this mode, when an instruction and noise other than the controllable instruction contents are input, they are recognized as unnecessary words.

In step S9, it is determined whether or not the instruction contents recognized in step S6 indicates the end (for example, “terminate”). If they indicate the end (YES), then the arithmetic process is terminated. Otherwise (NO), control is passed to step S3. That is, if a control instruction indicating an end, for example, “terminate” is input by speech in this mode, control is returned to the mode in which a controllable target equipment is selected (steps S3 and S4). Although a registered word relating to equipment control for recognition, that is, a control instruction, is not input by speech after a predetermined time, control is returned to the mode in which the target equipment is selected (not shown in FIG. 3).

In step S9, it is determined whether or not the instruction contents recognized in step S6 indicate standby (for example, “standby”). If the word indicates “standby” (YES), then control is passed to step S1. Otherwise (NO), control is passed to step S10. That is, if a word of an instruction to queue the speech recognition remote controller, for example, “standby” is input by speech in the mode in which the target equipment is selected, then control is returned to a password reception mode.

In step S10, it is determined whether or not the instruction contents recognized in step S6 indicates a word referring to apower-off status (for example, “close sesame”) If it is a word indicating the off status (YES), then the arithmetic process terminates. Otherwise (NO), control is passed to step S10. That is, if a user input “close sesame” by speech, the speech recognizer itself can be powered off, thereby completely terminating the system.

When the system is resumed, and the operation system of the central control circuit 8 is activated, the application software relating to the system is to be activated only. When the operation system is suspended, the activation can be performed by physically pressing the power button of the system.

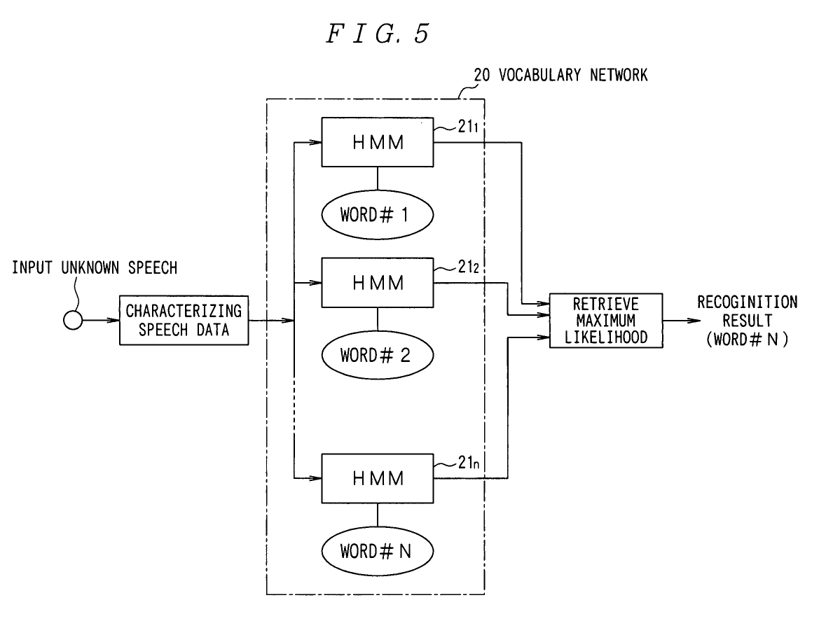

FIG. 5 shows the principle of the process using a hidden Markov model (hereinafter referred to as an HMM for short) in the speech recognizing processes performed in steps S1, S3, and S₆ shown in FIG. 3. When the speech recognizing process is performed, first the speech detected by the microphone 3 is converted into a digitized spectrum in a Fourier transform or a wavelet transformation, and the speech data is characterized using a speech modeling method such as a linear predication analysis, a cepstrum analysis, etc. on the spectrum. Then, for the characterized speech data, the likelihood of an acoustic model 21 of each word registered in a vocabulary network 20 read in the speech recognizing process in advance is calculated using the Viterbi algorithm. The registered word is modeled in a serial connection network of the HMM corresponding to a serial connection (speech unit label series) in a speech unit, and the vocabulary network 20 is modeled as a serial connection network corresponding to a registered word group registered in the registered vocabulary list. Each registered word is configured in a speech unit of a phoneme, etc., and the likelihood is calculated for each speech unit. When the termination of utterance of a user is checked, the registered word having the largest accumulation value of likelihood is detected from the registered vocabulary list, and the registered word is output as a registered word recognized as contained in the speech.

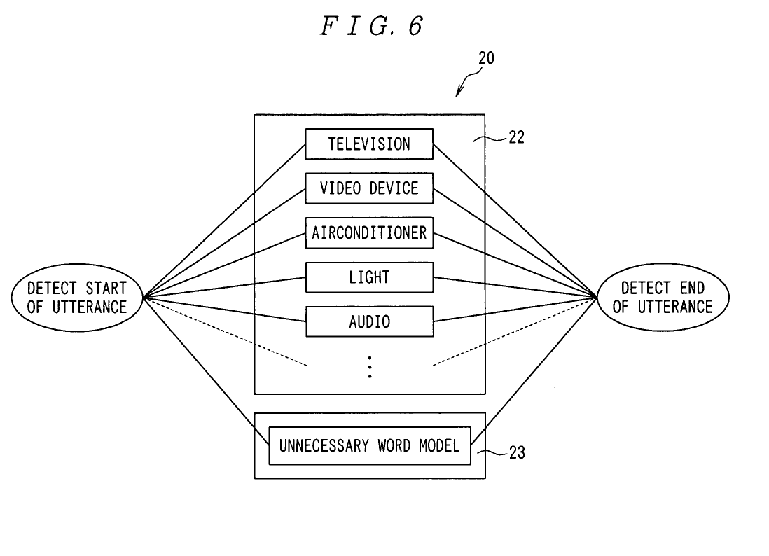

In the present invention, as shown in FIG. 6, a virtual model 23 for recognition of an unnecessary word is set together with a vocabulary network 22 of registered words as in the HMM in the representation of a word. As the virtual model 23 for recognition of an unnecessary word, a garbage model method proposed by H. Boulard, B. D'hoore and J. M. Boite, “Optimizing Recognition and Rejection Performance in Wordspotting Systems,” Proc. ICASSP, Adelaide, Australia, pp.I-373-376, 1994, etc. Thus, when an object other than a word to be controlled, that is, utterance and noise containing no registered words is input as speech, the likelihood of a virtual model corresponding to the unnecessary word is set larger than the likelihoods of all registered words, thereby selecting a virtual model having the largest likelihood, and successfully constructing a system capable of correctly determining the input of an unnecessary word. Since the virtual model 23 for recognition of an unnecessary word is used, a small portable remote controller can be formed without increasing the calculation load at a practical level of recognizing process although a rejection capability is assigned.

In the conventional method using only the vocabulary network 20 simply formed by the vocabulary network 22 of registered words without the virtual model 23 for recognition of an unnecessary word, there can necessarily be a malfunction due to an unknown word and an unnecessary word other than a word to be recognized or misrecognition from the utterance beyond the prediction of the system. Especially, in the status in which a speech recognizing process is constantly performed, there can be the problem that misrecognition frequently occurs by the noise caused on normal living conditions in a use environment, for example, the conversation among friends, the sound of the steps of the person walking near the remote controller, the utterance of pets, etc., the noise made in the cooking operation in the kitchen, etc. If the allowance range of the matching determination with a registered word is strictly set to reduce the misrecognition, the misrecognition can actually be reduced, but a target word to be recognized can also be rejected frequently, thereby requiring repeated utterance and constituting a nuisance for a user. Furthermore, there can be a method of listing unnecessary words in the registered vocabulary list, but it is not practical to list all unnecessary words because the resultant registered vocabulary list is too large and the required amount of calculation is extravagant.

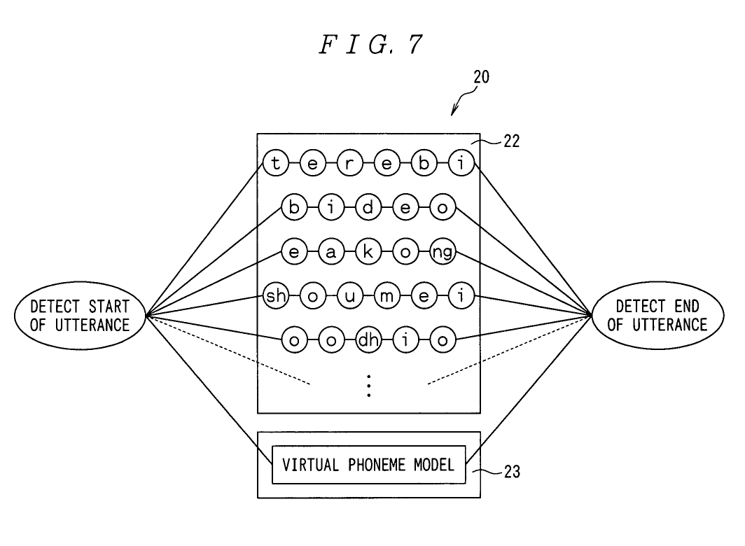

FIG. 6 shows a vocabulary network of the names of target equipment in the speech recognizing process performed in step S4 shown in FIG. 3. The vocabulary network 20 represents registered words for selection of target equipment, that is, the names 22 of the target equipment and the unnecessary word model 23. In more detail, each registered word is configured as shown in FIG. 7 representing a corresponding phoneme label series. The unnecessary word model 23 is formed as a virtual phoneme model obtained by equalizing all phoneme models, and has the topology similar to those of the phoneme HMM models of the speech of general people. The virtual phoneme model obtained by equalizing all available phonemes is generated as follows. That is, a model is generated using all phonemes as an HMM, the HMM is formed as a plurality of status transition series, and each status is formed by a mixed Gaussian distribution. Then, a set of Gaussian distribution to be shared among phonemes is selected from the mixed Gaussian distribution, an amendment is made to the mixed Gaussian distribution with a weight for each phoneme, and a virtual phoneme model is obtained by equalizing all available phonemes. The virtual phoneme model with all available phoneme equalized is not limited to a product from one cluster, all speech units are divided into a plurality of (for example, three to five units) clusters, and a model can be formed from among the clusters. Therefore, when a registered word is uttered by a user, the likelihood of the registered word is necessarily large. However, when a word other than a registered word is uttered, the likelihood of a virtual phoneme model becomes larger as a result, thereby enhancing the probability of recognition as an unnecessary word. For example, if the word “takibi” which is not described in the vocabulary network 22 of registered words shown in FIG. 7 is input when the names of target equipment as registered words such as “TV”, “video”, “air-con”, “light”, “audio”, etc. are registered, and if there is no unnecessary word models set, then the likelihood of a described word, that is, a word having a similar phoneme configuration among the registered words (for example, “terebi” in the registered vocabulary list shown in FIG. 7) is the largest and causes misrecognition. However, if an unnecessary word is set, there is the strong possibility that the likelihood of the virtual phoneme model is the largest according to the probability theory, and the recognition as an unnecessary word can reduce the misrecognition to a large extent.

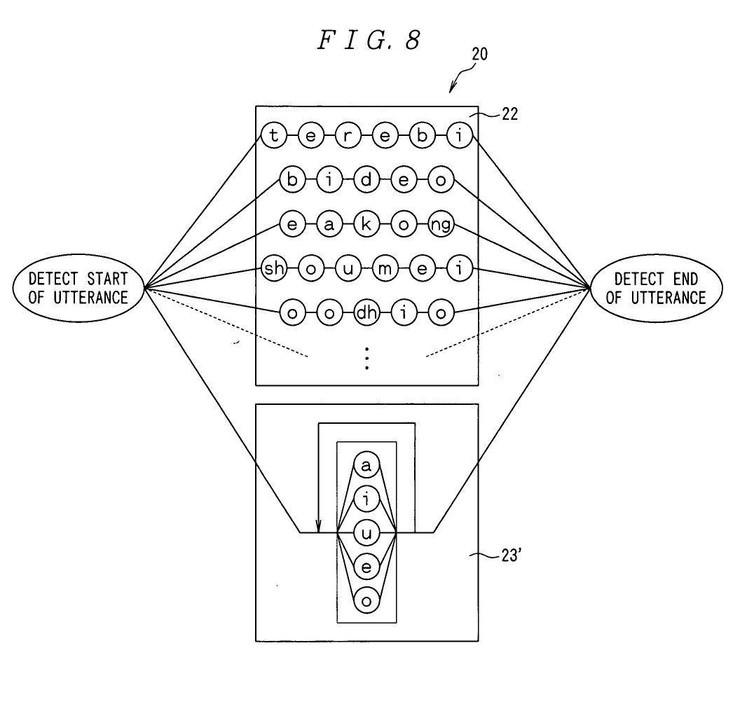

The unnecessary word model shown in FIG. 8 shows a self-loop of phonemes forming vowels. That is, the unnecessary word model is a set of HMMs corresponding to the phonemes of vowels, and has a self-loop from the end point to the starting point of the set. The likelihoods of the HMMs corresponding to the phonemes of vowels are calculated for each acoustic parameter for the digitized acoustic parameter series, the largest values are accumulated, and the likelihood of an unnecessary word model is obtained. This is based on the characteristic that almost all words contain vowels, and the analysis of phonemes can be represented by consonants, vowels, friction sounds, explosives, etc. with larger acoustic energy assigned to vowels. That is, the likelihood of an unnecessary word model is calculated as continuous sounds of vowels of all words. Therefore, when a registered word is uttered by a user, the phonemes other than vowels such as consonants become unfit for an unnecessary word model. Therefore, the likelihood of an unnecessary word model is lower than the likelihood of a registered word, and as a result, the probability of recognition as a registered word is enhanced. However, when a word other than a registered word is uttered, a phoneme model corresponding to a registered word indicates a lower value for the phoneme other than a vowel such as a consonant, etc. Therefore, the likelihood of an unnecessary word model indicating continuous sounds of vowels is higher and the probability of recognition as an unnecessary word is high, thereby reducing misrecognition. This method is used when it is hard to obtain the label series of the above-mentioned virtual phoneme model, and when existing speech recognition software formed by phoneme models is used.

Depending on the actual use situation, when the unnecessary word recognition rate is low and when the recognition rate is too high and a target instruction word can be recognized as an unnecessary word, the optimization of a recognition rate can be performed by multiplying the likelihood obtained for an unnecessary word model by a virtual phoneme model and an unnecessary word model using vowel phonemes by an appropriate factor.

(Embodiment 1)

Described below is the first embodiment of the present invention.

In this embodiment, as shown in FIG. 7, the virtual phoneme model 23 obtained by equalizing all phoneme models is provided as an unnecessary word model. The phoneme model 23 and the registered word list described in the table 1, that is, the vocabulary network 22 of registered words are provided in parallel in the vocabulary network 20. The vocabulary network 20 is read in the speech recognizing process in step S3 shown in FIG. 3 for a speech remote controller. As unnecessary words, “takibi”, “takeo”, and “fami-com” are input by speech five times for each word. As a result, the probability of recognition as an unnecessary word, that is, the probability of correct recognition as no registered word is 100%. To check the recognition rate of a target word, that is, a registered word such as “terebi”, “bideo”, “eakon”, “shoumei”, and “oodeo”, each word is uttered ten times, and the resultant correct recognition rate for all these words is 94%.

TABLE 1

| Target vocabulary | Phoneme representation |
|---|---|
| Terebi | 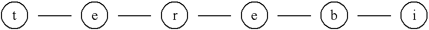 |
| Bideo | 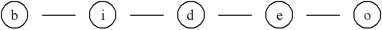 |
| Eakon | 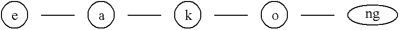 |
| Shoumei | 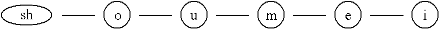 |
| Oodeo | 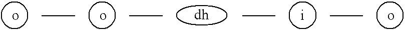 |

(Embodiment 2)

Described below is the second embodiment of the present invention.

In this embodiment, as shown in FIG. 8, the self-loop model 23′ configured by HMMs corresponding to the phonemes of vowels, that is, “a”, “i”, “u”, “e”, and “o” are provided as unnecessary word models. The self-loop model 23′ and the registered word list described in the table 1, that is, the vocabulary network 22 of registered words are provided in parallel in the vocabulary network 20. The vocabulary network 20 is read in the speech recognizing process in step S3 shown in FIG. 3 for a speech remote controller. As unnecessary words, “takibi”, “takeo”, and “fami-com” are input by speech five times for each word. As a result, the probability of recognition as an unnecessary word, that is, the probability of correct recognition as no registered word is 100%. To check the recognition rate of a target word, that is, a registered word such as “terebi”, “bideo”, “eakon”, “shoumei”, and “oodeo”, each word is uttered ten times, and the resultant correct recognition rate for all these words is 90%.

(Embodiment 3)

Described below is the third embodiment of the present invention.

In this embodiment, as in the first embodiment as shown in FIG. 7, the virtual phoneme model 23 obtained by equalizing all phoneme models is provided as an unnecessary word model. The phoneme model 23 and the registered word list described in the table 1, that is, the vocabulary network 23 of registered words are provided in parallel in the vocabulary network 20. The vocabulary network 20 is read in the speech recognizing process routine in step S3 shown in FIG. 3 for a speech remote controller. As unnecessary words, “a, i, u, e, o”, “eeto”, “keibi”, “ehen”, “shouchi” and “oodekoron” are input by speech ten times for each word. As a result, the probability of recognition as an unnecessary word, that is, the probability of correct recognition as no registered word is 92%.

(Embodiment 4)

Described below is the fourth embodiment of the present invention.

In this embodiment, as in the second embodiment as shown in FIG. 8, the self-loop model 23′ configured by HMMs corresponding to the phonemes of vowels, that is, “a”, “i”, “u”, “e”, and “o” are provided as unnecessary word models. The self-loop model 23′ and the registered word list described in the table 1, that is, the vocabulary network 22 of registered words are provided in parallel in the vocabulary network 20. The vocabulary network 20 is read in the speech recognizing process in step S3 shown in FIG. 3 for a speech remote controller. As unnecessary words, “a, i, u, e, o”, “eeto”, “keibi”, “ehen”, “shouchi” and “oodekoron” are input by speech ten times for each word. As a result, the probability of recognition as an unnecessary word, that is, the probability of correct recognition as no registered word is 93%.

(Embodiment 5)

Described below is the fifth embodiment of the present invention.

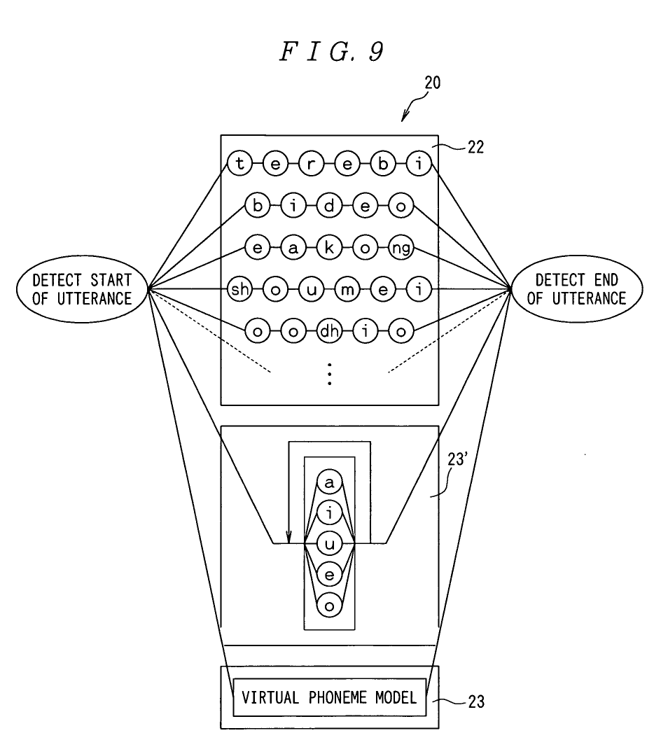

In this embodiment, as shown in FIG. 9, the virtual phoneme model 23 obtained by equalizing all phoneme models, and the self-loop model 231 configured by HMMs corresponding to the phonemes of “a”, “i”, “u”, “e”, and “o” are provided as unnecessary word models. The models 22 and 23 and the registered word list described in the table 1, that is, the vocabulary network 22 of registered words are provided in parallel in the vocabulary network 20. The vocabulary network 20 is read in the speech recognizing process routine in step S103 shown in FIG. 3 for a speech remote controller. As unnecessary words, “a, i, u, e, o”, “eeto”, “keibi”, “ehen”, “shouchi” and “oodekoron” are input by speech ten times for each word. As a result, the probability of recognition as an unnecessary word, that is, the probability of correct recognition as no registered word is 100%. To check the recognition rate of a target word, that is, a registered word such as “terebi”, “bideo”, “eakon”, “shoumei”, and “oodeo”, each word is uttered ten times, and the resultant correct recognition rate for all these words is 88%.

(Embodiment 6)

Described below is the sixth embodiment of the present invention.

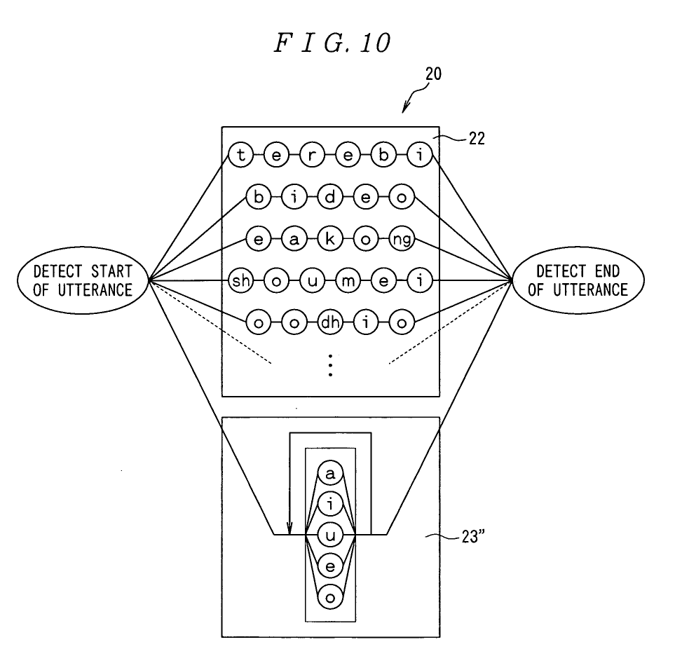

In this embodiment, as shown in FIG. 10, HMMs 23″ corresponding to the phonemes of “a”, “i”, “u”, “e”, and “o”, that is, the unnecessary word models shown in FIG. 8 excluding the self-loop are provided as unnecessary word models. The self-loop model 23″ and the registered word list described in the table 1, that is, the vocabulary network 22 of registered words are provided in parallel in the vocabulary network 20. The vocabulary network 20 is read in the speech recognizing process in step S3 shown in FIG. 3 for a speech remote controller. As unnecessary words, “a, i, u, e, o”, “eeto”, “keibi”, “ehen”, “shouchi” and “oodekoron” are input by speech ten times for each word. As a result, the probability of recognition as an unnecessary word, that is, the probability of correct recognition as no registered word is 23%.

### COMPARATIVE EXAMPLE 1

Described below is the first comparative example according to the present invention.

In this comparative example, as shown in FIG. 10, the vocabulary network 20 configured by the registered word list described in the table 1, that is, the vocabulary network 22 of registered words without using a virtual model for recognition of an unnecessary word model is read to the speech recognizing process routine in step S3 shown in FIG. 3 to prepared the speech recognition remote controller. Then, as unnecessary words, “takibi”, “takeo”, and “famikon” are input by speech five times for each word. As a result, “takibi” is completely misrecognized as “terebi”, “takeo” is completely misrecognized as “bideo”, and “fami-com” is completely misrecognized as “eakon”. Therefore, the probability of recognition as an unnecessary word, that is, the probability of no misrecognition as a registered word, is 0%. To check the recognition rate for target words, that is, the registered words “terebi”, “bideo”, “eakon”, “shoumei”, and “oodeo”, each word is input by speech ten times, and the correct answer rate is 98% for all these words.

### COMPARATIVE EXAMPLE 2

Described below is the second comparative example according to the present invention.

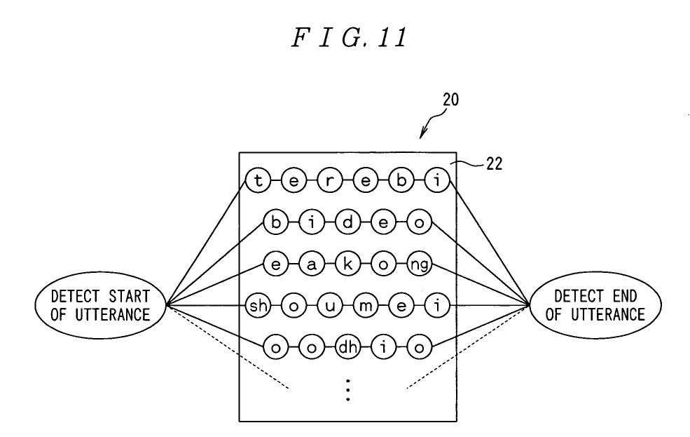

In this comparative example, as in the first comparison, as shown in FIG. 11, the vocabulary network 20 configured by the registered word list described in the table 1, that is, the vocabulary network 22 of registered words without using a virtual model for recognition of an unnecessary word is read to the speech recognizing process routine in step S3 shown in FIG. 3 to prepared the speech recognition remote controller. Then, as unnecessary words, “a, i, u, e, o”, “eeto”, “keibi”, “ehen”, “shouchi” and “oodekoron” are input by speech ten times for each word. As a result, “a, i, u, e, o” is easily misrecognized as “bideo”, “eeto” is easily misrecognized as “eakon”, “keibi” is easily misrecognized as “terebi”, “ehen” is easily misrecognized as “eakon”, “shouchi” is easily misrecognized as “shoumei”, “oodekoron” is easily misrecognized as “oodeo”. Therefore, the probability of recognition as an unnecessary word, that is, the probability of no misrecognition as a registered word, is 0%.

In the present embodiment, the speech instruction information memory 7 corresponds to the storage means, the microphone 3 corresponds to the means for inputting speech uttered from a user, the speech instruction recognition circuit 6 corresponds to the speech recognition means, and the infrared emitting unit 2 corresponds to the transmission means.

The second embodiment of the present invention is explained below by referring to the attached drawings. In this embodiment, the speech recognizing process in the first embodiment is performed by recognizing the registered word contained in the speech of a user, and applying the information terminal for controlling the electronic mail transmitting and receiving function, the schedule managing function, the speech memo processing function, the speech timer function, etc. The speech memo processing function is the function of allowing a user to input by speech the contents of a memo, recording the speech, and recognizing the speech at a request of the user. The speech timer function is the function of allowing a user to input by speech the contents of a notice, recording the speech, inputting a notice timing, and recognizing the speech with the notice timing.

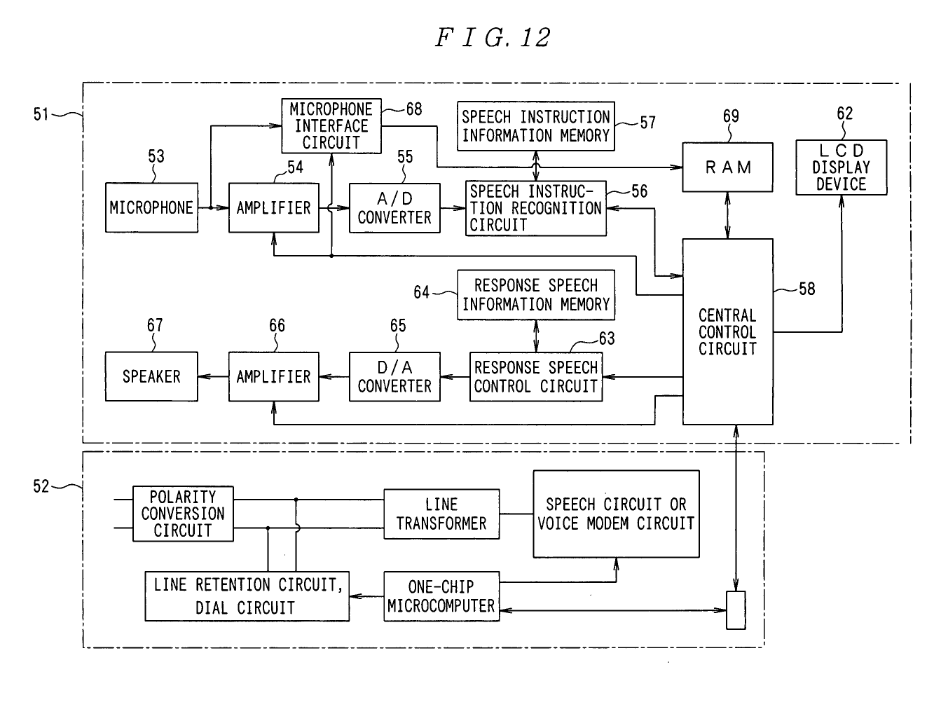

FIG. 12 is a primary block diagram of the information terminal by applying an analog telephone according to the second embodiment of the present invention. The information terminal shown in FIG. 12 comprises a speech recognition unit 51 for recognizing the registered word contained in the speech of the user, and performing the electronic mail transmitting and receiving function, the schedule managing function, the speech memo processing function, the speech timer function, etc. and a communications unit 52 for connection to a communications line, etc. based on the recognition result. The speech of the user is input from a microphone 53 of the speech recognition unit 51, passes through an amplifier 54, and is converted into a digitized acoustic parameter by an A/D converter 55. A speech instruction recognition circuit 56 calculates the likelihood of a registered word in the registered vocabulary list stored and registered in speech instruction information memory 57 for the digitized acoustic parameter in a speech unit, and what is related to the largest accumulation value of the likelihood is extracted as the closest to the speech of the user. The speech instruction recognition circuit 56 simultaneously calculates the likelihood of an unnecessary word stored and registered in the speech instruction information memory 57 for a digitized acoustic parameter. When the likelihood of the unnecessary word is larger than the likelihood of the registered word, it is assumed that no registered word has been extracted from the digitized acoustic parameter.

The speech instruction information memory 57 stores as registered vocabulary lists an electronic mail transmitting vocabulary list storing a registered word relating to the electronic mail transmitting function, an electronic mail receiving vocabulary list storing a registered word relating to the electronic mail receiving function, a schedule management vocabulary list storing a registered word relating to the schedule managing function, a speech memo vocabulary list storing a registered word relating to the speech memo processing function, a speech time vocabulary list storing a registered word relating to the speech timer function, and control codes corresponding to a mail transmit command and a mail receive command which are registered words. If an electronic mail transmission starting password is extracted, that is, obtained as a recognition result, in the speech instruction recognition circuit 56, then the arithmetic process described later is performed to control the electronic mail transmitting function based on the speech of the user, the user is allowed to input by speech the contents of the mail, the speech is detected by the microphone 53, stored as speech data in RAM 69 through a microphone interface circuit 68. When an electronic mail transmit command is input, the control code for control of a telephone corresponding to the command is called from the speech instruction information memory 57, and is transmitted to the communications unit 52, and the speech data is attached to the electronic mail and is transmitted. Similarly, when the speech instruction recognition circuit 56 obtains an electronic mail reception starting password as a recognition result, the arithmetic process described later for controlling the electronic mail receiving function is performed depending on the speech of the user. When an electronic mail receive command is input, the control code for control of a telephone corresponding to the command is called from the speech instruction information memory 57, and is transmitted to the communications unit 52, thereby receiving electronic mail to which speech data is attached, and recognizing the speech data by a speaker 67 through a D/A converter 65 and the amplifier 16. The control code is not specifically designated so far as it can control the communications unit 52. However, since an AT command is commonly used, an AT command is also adopted in the present embodiment.

When the speech instruction recognition circuit 56 obtains a starting password of the schedule managing function as a recognition result, a central control circuit 58 performs the arithmetic process described later for controlling the schedule managing function depending on the speech of the user, the user is allowed to input by speech the contents of the schedule, the speech is detected by the microphone 53 and is stored as speech data in the RAM 69 through the microphone interface circuit 68, the execution day of the schedule is input, and the execution day is associated with the speech data, thereby performing the schedule. When a starting password for the speech memo processing function is extracted, that is, obtained as a recognition result, in the speech instruction recognition circuit 56, the arithmetic process described later for controlling the speech memo processing function depending on the speech of the user is performed in the central control circuit 58, the user is allowed to input by speech the contents of the memo, the speech is detected by the microphone 53 and stored as speech data in the RAM 69 through the microphone interface circuit 68, the speech data is called from the RAM 69 at a request of the user, and is regenerated by the speaker 67 through the D/A converter 65 and the amplifier 16. Furthermore, when a starting password for the speech timer generating function is obtained as a recognition result in the speech instruction recognition circuit 56, the arithmetic process described later for controlling the speech timer function depending on the speech of the user in the central control circuit 58, the user is allowed to input the contents of a notice, the speech is detected by a microphone and is stored as speech data in the RAM 69 through the microphone interface circuit 68, the notice timing of the speech is input, the speech data is called from the RAM 69 with the notice timing, and is regenerated by the speaker 67 through the D/A converter 65 and the amplifier 16.

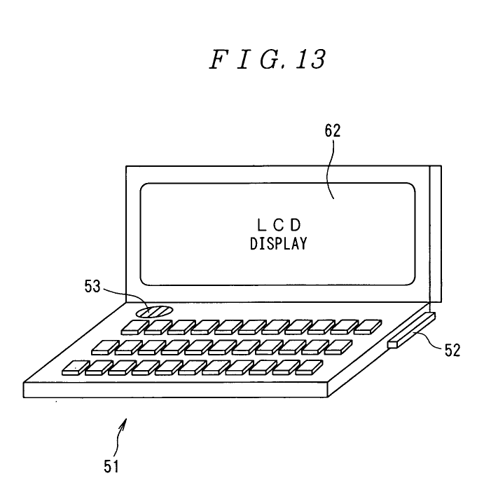

Available hardware is not specifically designated so far as the basic function according to FIG. 12 is included. In the description below, a commonly marketed personal computer is explained as shown in FIG. 13 when it is used as the speech recognition unit 51.

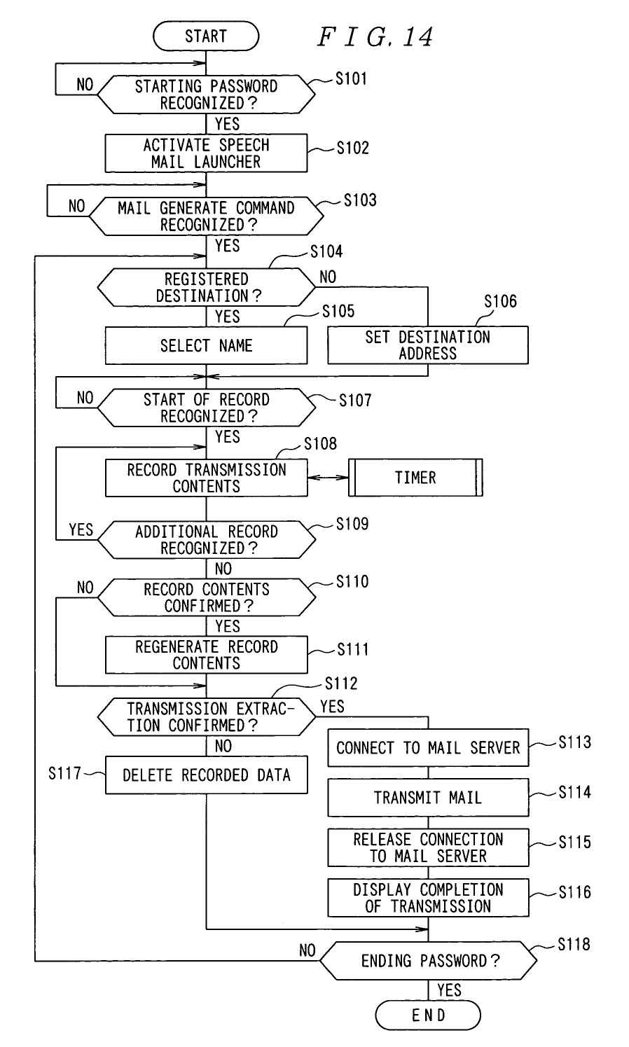

FIG. 14 shows the process performed by the information terminal shown in FIG. 13 in the flowchart of the arithmetic process of transmitting electronic mail depending on the speech of a user. Although no step for communications is provided in the flowchart, the information obtained in the arithmetic process is updated and stored in the storage device at any time, and necessary information is read at any time from the storage device.

When the arithmetic process is performed, first in step S101, the speech detected in the microphone 53 is read, and the speech recognizing process of recognizing whether the starting password (for example, the word “electronic mail transmission”) which is the registered word contained in the speech is contained or the noise and speech other than the starting password, that is, unnecessary words only, are contained. If the starting password is contained (YES), control is passed to step S102. Otherwise (NO), the process flow is repeated.

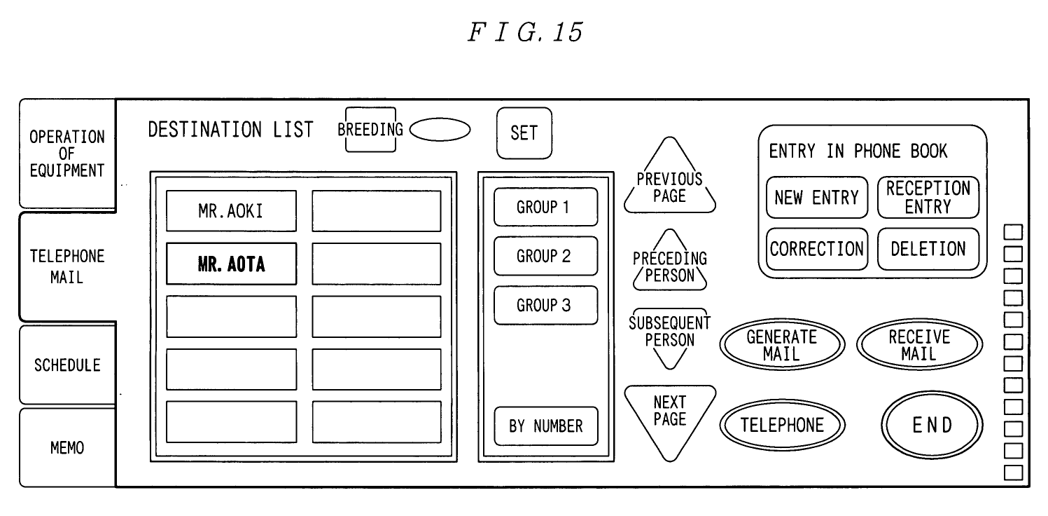

Instep S102, the electronic mail transmitting vocabulary list is read as a registered vocabulary list, and a speech mail launcher is activated as shown in FIG. 15 so that a user can display on an LCD display device 62 a list of registered words with which the user can issue an instruction. A registered word for display on the LCD display device 62 can be, for example, a mail generate command (for example, “generate mail”) to be uttered when mail is to be generated.

In step S103, the speech detected by the microphone 53 is read, the speech recognizing process of recognizing whether a mail generate command is contained in the speech, or only noise and speech other than the mail generate command, that is, an unnecessary word, is contained is performed. If the speech contains a mail generate command (YES), control is passed to step S104. Otherwise (NO), the process flow is contained.

Then, in step S104, the speech detected in the microphone 53 is read, and the speech recognizing process of recognizing whether the destination list select command (for example, a word “destination list”) which is a registered word to be contained in the speech is contained, or only the noise and speech other than the destination list select command, that is, the unnecessary words, are contained is performed. If the destination list select command is contained in the speech (YES), then control is passed to step S105. Otherwise (NO), control is passed to step S106.

In step S105, as shown in FIG. 15, a list of the names of the persons whose mail addresses are registered, that is, the names of the persons whose mail addresses are stored in a predetermined data area of a storage device, is displayed on the LCD display device 62, the speech detected by the microphone 53 is read, and the speech recognizing process of recognizing the names of the persons which are the registered words contained in the speech is performed, the mail address corresponding to the name of the person is called, and control is passed to step S107.

In step S106, a message requesting to utter the mail address of a mail destination is displayed on the LCD display device 62, the speech detected by the microphone 53 is read, the speech recognizing process of recognizing alphabetical characters which indicate the registered word contained in the speech is performed, and the mail address of the destination is recognized, thereby passing control to step S107.

In step S107, the speech recognizing process of recognizing a record start command (for example, “start recording”) which is a registered word is performed on the speech detected by the microphone 53, and it is determined whether or not the speech contains the record start command. if the record start command is contained (YES), control is passed to step S108. Otherwise (NO), the process flow is repeated.

In step S108, a message requesting to utter the contents of mail is displayed on the LCD display device 62, speech data is generated by recording the speech data detected by the microphone 53 for a predetermined time, and the speech data is stored in a predetermined data area of the storage device as the contents of mail.

In step S109, the speech recognizing process of recognizing an additional record command (for example, “additional recording”) which is a registered word is performed on the speech detected by the microphone 53, and it is determined whether or not the speech contains the additional record command. If the additional record command is contained (YES), control is passed to step S108. Otherwise (NO), control is passed to step S110.

In step S110, the speech detected by the microphone 53 is read, and it is determined whether or not the speech contains a record contents confirm command (for example, “confirm record contents”). If the speech contains the record contents confirm command (YES), control is passed to step S111. Otherwise (NO), control is passed to step S112.

In step S111, the speech data generated in step S108, that is, the contents of the mail, is read from a predetermined data area in the storage device, the speech data is regenerated by the speaker 67, and control is passed to step S112.

In step S112, the speech detected by the microphone 53 is read, and it is determined whether or not the speech contains a transmit command (for example, “confirm transmission”). If the transmit command is contained (YES), control is passed to step S113. Otherwise (NO), control is passed to step S114.

In step S113, an AT command for calling up a provider is read from a predetermined data area of the storage device, and the AT command is transmitted to a speech communications unit 102 for connection to the mail server of the provider.

Then, control is passed to step S114, the speech data generated in step S108, that is, the contents of mail, is read from a predetermined data area of the storage device, the speech data is attached to electronic mail, and the electronic mail is transmitted to the mail address read in step S105 or the mail address which is input in step S106.

Then in step S115, an AT command specifying a disconnection of a circuit is called from a predetermined data area of the storage device, and the AT command is transmitted to the communications unit 52.

In step S116, a message notifying that the transmission of the electronic mail has been completed is displayed on the LCD display device 62, and then control is passed to step S118.

In step S117, the speech data generated in step S108, that is, the contents of mail, is deleted from a predetermined data area of the storage device, and control is passed to step S118.

In step S118, the speech recognizing process of recognizing a terminate command (for example, “terminate”) which is a registered word is performed on the speech detected by the microphone 53, and it is determined whether or not the speech contains the terminate command. If the terminate command is contained (YES), the arithmetic process is terminated. Otherwise (NO), control is passed to step S104.

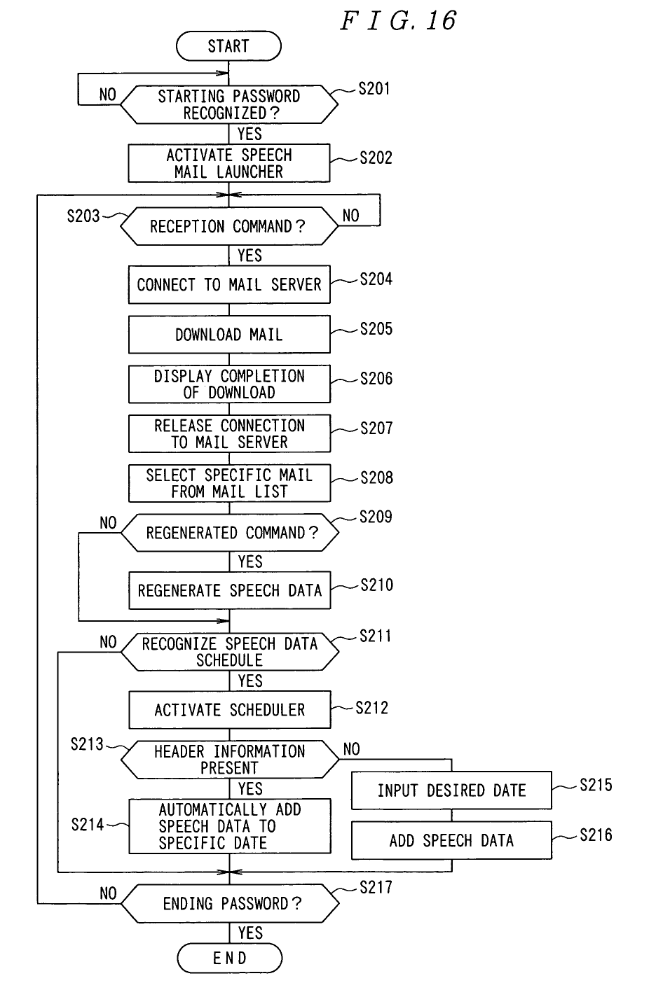

FIG. 16 shows the process performed by the information terminal shown in FIG. 13, and is a flowchart of the arithmetic process for receiving, etc. electronic mail according to the speech of the user. In this flowchart, there is no step for communications. However, the information obtained in the arithmetic process is updated and stored in the storage device, and necessary information is read from the storage device. When the arithmetic process is performed, first in step S201, the speech detected by the microphone 53 is read, and the speech recognizing process of recognizing whether the speech contains a starting password (for example, “receive electronic mail”) or noise or speech other than the starting password, that is, only unnecessary words is performed. If the starting password is contained (YES), control is passed to step S202. Otherwise (NO), the process flow is repeated.

Then, in step S202, an electronic mail receiving vocabulary list is read as a registered vocabulary list, and a speech mail launcher is activated, and a list of registered words with which a user can issue an instruction is displayed on the LCD display device 62. A registered word to be displayed on the LCD display device 62 can be, for example, a mail receive command (for example, “receive mail”), etc. uttered when mail is to be received.

Then, in step S203, the speech detected by the microphone 53 is read, and it is determined whether or not the speech contains a mail receive command. If the mail receive command is contained (YES), control is passed to step S204. Otherwise (NO), the process flow is repeated.

Then, in step S204, an AT command for a call to a provider is called from a predetermined data area of the storage device, and the AT command is transmitted to the speech communications unit 102 for connection to the mail server of the provider.

Then, in step S205, electronic mail is received from the mail server connected in step S204, and the electronic mail is stored in a predetermined data area of the storage device.

Then, control is passed to step S206, and a message notifying that the electronic mail has been completely received is displayed on the LCD display device 62.

Then, in step S207, the AT command indicating the disconnection of a line is called from a predetermined data area of the storage device, and the AT command is transmitted to the communications unit 52.

In step S208, a list of mail received in step S205 is displayed on the LCD display device 62, the speech detected by the microphone 53 is read, the speech recognizing process of recognizing a mail select command which is a registered word contained in the speech is performed, and a user is allowed to select specific mail from a list of mail. A mail select command can be anything so far as a user is allowed to select a specific mail. For example, when the name of a mail transmitter is displayed in a mail list, the listed name can be used.

Then, in step S209, the speech recognizing process of recognizing a regenerate command (for example, “regenerate”) which is a registered word is performed on the speech detected by the microphone 53, and it is determined whether or not the application contains a regenerate command. If a regenerate command is contained (YES), then control is passed to step S210. Otherwise (NO), control is passed to step S211.

In step S210, the speech data attached to the mail selected in step S208, that is, the contents of mail, is read from a predetermined data area of the storage device, and the speech data is regenerated by the speaker 67, thereby passing control to step S211.

In step S211, the speech recognizing process of recognizing a schedule register command (for example, “register schedule”) which is a registered word is performed on the speech detected by the microphone 53, and it is determined whether or not the speech contains the schedule register command. If a schedule register command is contained (YES), then control is passed to step S212. Otherwise (NO), control is passed to step S217.

In step S212, a schedule management vocabulary list is read as a registered vocabulary list, a scheduler is activated, and a list of registered words with which the user can issue an instruction is displayed on the LCD display device 62.

Then, in step S213, it is determined whether or not header information (for example, information designating a date, etc.) is described in the mail selected in step S208. If header information is described (YES), then control is passed to step S214. Otherwise (NO), control is passed to step S215.

In step S214, the speech data attached to the mail selected in step S208, that is, the contents of mail, is stored in a predetermined data area of the storage device as the contents of a schedule of the date of the header information described in the mail. Then, a message requesting to input a select large/small item command (for example, “private”, “meet”, etc.) of the contents of a schedule is displayed on the LCD display device 62, the speech detected by the microphone 53 is read, and the speech recognizing process of recognizing a select large/small item command of the contents of a schedule which is a registered word contained in the speech is performed. The recognition result is stored in a predetermined data area of the storage device using the recognition result as the speech data, that is, a large/small item of the schedule contents, and then control is passed to step S217.

On the other hand, in step S215, a message requesting input of the execution day of a schedule is displayed on the LCD display device 62, the speech detected by the microphone 53 is read, and the speech recognizing process of recognizing a year-month-day input command (for example, “date”) which is a registered word contained in the speech is performed.

Then, in step S216, the speech data attached to the mail selected in step S208 is stored in a predetermined data area of the storage device as the contents of the schedule on the date recognized in step S215. Then, the message requesting to input a select large/small item command (for example, “private”, “meet”, etc.) of the schedule contents is displayed on the LCD display device 62, the speech detected by the microphone 53 is read, and the speech recognizing process of recognizing the select large/small item command of the schedule contents which is registered words contained in the speech is performed. Then, the recognition result is stored in a predetermined data area of the storage device as the speech data, that is, a large/small item of the schedule contents, thereby passing control to step S217.

In step S217, the speech recognizing process of recognizing a terminate command (for example, “terminate”) which is a registered word is performed on the speech detected by the microphone 53, and it is determined whether or not the speech contains the terminate command. If the terminate command is contained (YES), the arithmetic process is terminated. Otherwise (NO), control is passed to step S203.

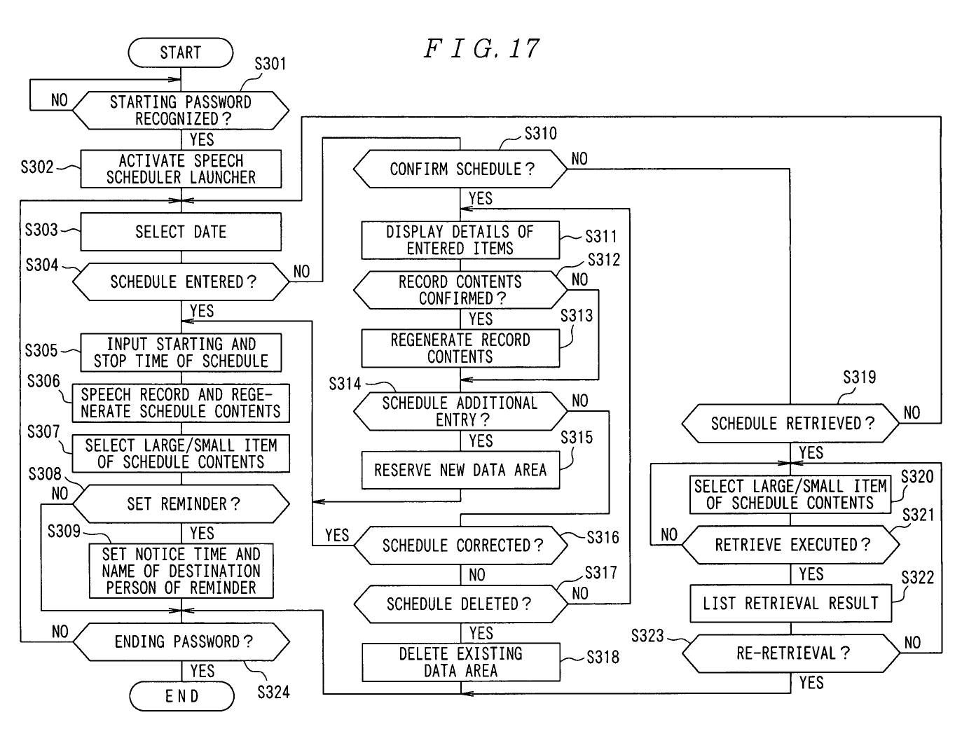

FIG. 17 shows the process performed by the information terminal shown in FIG. 13, and is a flowchart of the arithmetic process for performing the schedule managing function according to the speech of the user. In this flowchart, there is no step for communications. However, the information obtained in the arithmetic process is updated and stored in the storage device, and necessary information is read from the storage device. When the arithmetic process is performed, first in step S301, the speech detected by the microphone 3 is read, and the speech recognizing process of recognizing whether the speech contains a starting password (for example, “speech schedule”) or noise or speech other than the starting password, that is, only unnecessary words is performed. If the starting password is contained (YES), control is passed to step S302. Otherwise (NO), the process flow is repeated.

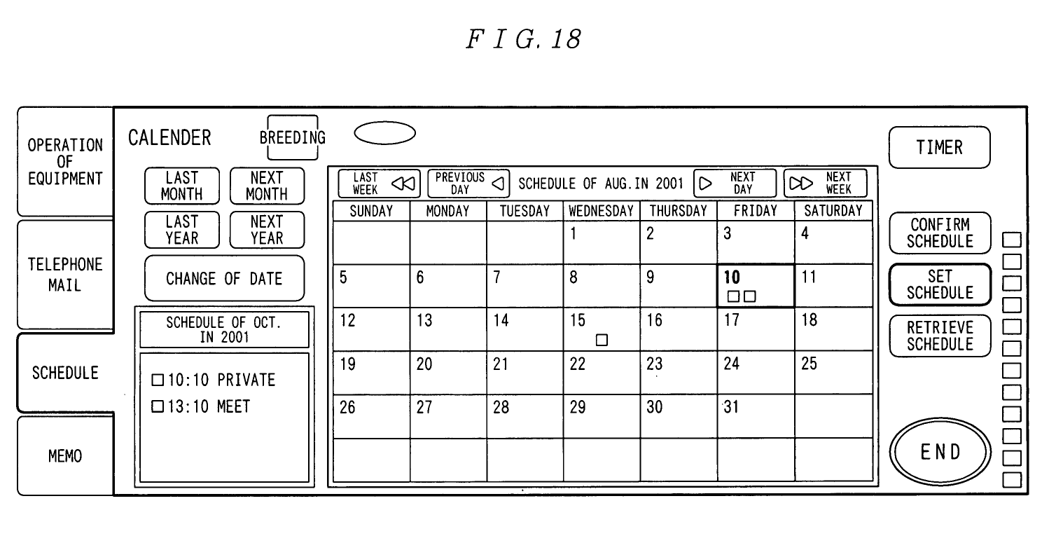

Then, instep S302, a schedule management vocabulary list is read as a registered vocabulary list, the speech schedule launcher is activated as shown in FIG. 18, and a list of registered words with which a user can issue an instruction can be displayed on the LCD display device 62. A registered word displayed on the LCD display device 62 can be, for example, a schedule register command (for example, “set schedule”) to be uttered when a schedule is registered, and a schedule confirm command (for example, confirm schedule) to be uttered when a schedule is confirmed.

Then, in step S303, a message requesting to utter the execution day of a schedule is displayed on the LCD display device 62, the speech detected by the microphone 53 is read, and the speech recognizing process of recognizing a year-month-day input command (for example, “date”) which is a registered word contained in the speech is performed.

Then, control is passed to step S304, and the speech recognizing process of recognizing a schedule register command which is a registered word is performed on the speech detected by the microphone 53, and it is determined whether or not the speech contains a schedule register command. If a schedule register command is contained (YES), then control is passed to step S305. Otherwise (NO), control is passed to step S310.

In step S305, the speech detected by the microphone 53 is read, the speech recognizing process of recognizing a schedule start/stop time input command (for example, “time”) which is a registered word contained in the speech is performed, and a user is requested to input the start and stop time of the schedule.

Then, in step S306, a message requesting to utter the contents of a schedule is displayed on the LCD display device 62, the speech detected by the microphone 53 is recorded for a predetermined time and speech data is generated, and the data in stored in a predetermined data area of the storage device as the contents of the schedule on the date recognized in step S303.

Then, in step S307, a message requesting to input a select large/small item command (for example, “private”, “meet”, etc.) of the contents of a schedule is displayed on the LCD display device 62, the speech detected by the microphone 53 is read, and the speech recognizing process of recognizing a select large/small item command of the contents of a schedule which is a registered word contained in the speech is performed. Then, the recognition result is stored in a predetermined data area of the storage device as the speech data generated in step S306, that is, a large/small item of the contents of the schedule.

In step S308, a message requesting to utter a set command of a reminder function (for example, “set reminder”) is displayed on the LCD display device 62, and the speech recognizing process of recognizing a reminder set command which is a registered word is performed on the speech detected by the microphone 53 is performed. Then, it is determined whether or not the speech contains the reminder set command. If the reminder set command is contained (YES), then control is passed to step S309. Otherwise (NO), control is passed to step S324. The reminder function refers to the function of announcing the contents of a schedule with a predetermined timing, and reminds the user of the presence of the schedule.

In step S309, a message requesting to input the name of a destination and the notice time of the reminder, etc. is displayed on the LCD display device 62, the speech detected by the microphone 53 is read, and the speech recognizing process of recognizing the notice time of the reminder which is the registered word contained in the speech the set command (for example, “number of minutes before a predetermined time”) of the name of the destination is performed, and the user is allowed to input the notice timing, etc. by the reminder function. At the next notice time of the reminder, the speech data generated in step S306, that is, the schedule contents, is read from a predetermined data area, the arithmetic process of regenerating the speech data using the speaker 67 is performed, and control is passed to step S324.

In step S310, the speech recognizing process of recognizing a schedule confirm command which is a registered word is performed on the speech detected by the microphone 53, and it is determined whether or not the schedule confirm command is contained in the speech. If a schedule confirm command is contained (YES), then control is passed to step S311. Otherwise (NO), control is passed to step S319.

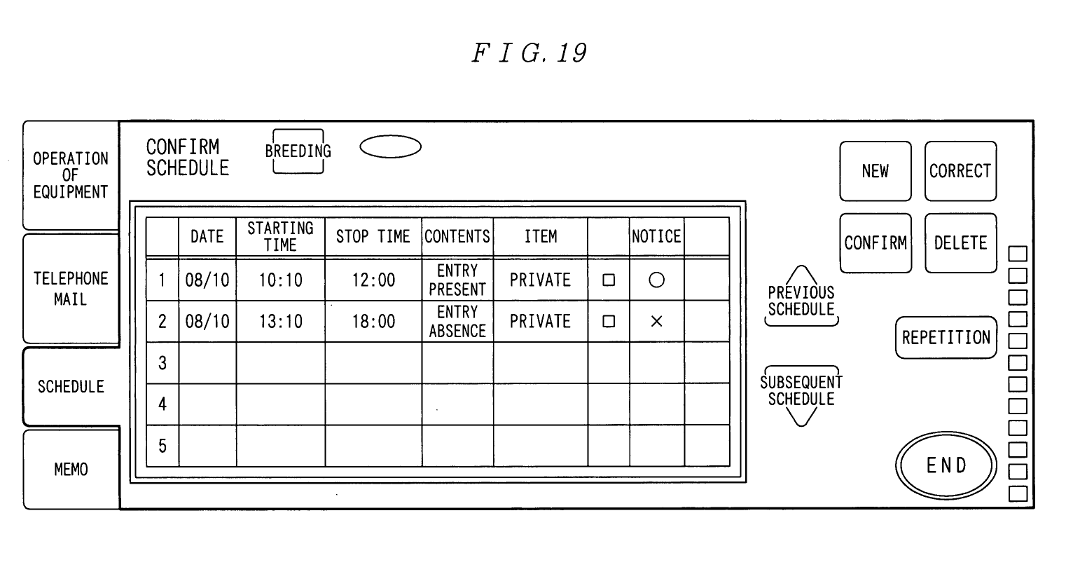

In step S311, as shown in FIG. 19, the large/small item of the schedule contents input in steps S214, S216, and S307 in the arithmetic process for receiving the electronic mail is read from a predetermined data area of the storage device, and a list of the items is displayed on the LCD display device 62.

In step S312, the speech recognizing process of recognizing a record contents confirm command (for example, “confirm”) which is a registered word is performed on the speech detected by the microphone 53, and it is determined whether or not the record contents confirm command is contained in the speech. If a record contents confirm command is contained (YES), then control is passed to step S313. Otherwise (NO), control is passed to step S314.

In step S313, the speech data corresponding to the large/small item listed on the LCD display device 62 in step S311, that is, the schedule contents, are regenerated by the speaker 67, and control is passed to step S314.

In step S314, the speech recognizing process of recognizing a schedule add/register command (for example, “set schedule”) which is a registered word is performed on the speech detected by the microphone 53, and it is determined whether or not the schedule add/register command is contained in the speech. Ifa schedule add/register command is contained (YES), then control is passed to step S315. Otherwise (NO), control is passed to step S316.

In step S315, a data area for registration of a new schedule is reserved in the storage device, and then control is passed to step S305.

On the other hand, in step S316, the speech recognizing process of recognizing a schedule amend command (for example, “amend”) which is a registered word is performed on the speech detected by the microphone 53, and it is determined whether or not the schedule amend command is contained in the speech. If a schedule amend command is contained (YES), then control is passed to step S305. Otherwise (NO), control is passed to step S317.

In step S317, the speech recognizing process of recognizing a schedule delete command (for example, “delete”) which is a registered word is performed on the speech detected by the microphone 53, and it is determined whether or not the schedule delete command is contained in the speech. If a schedule delete command is contained (YES), then control is passed to step S318. Otherwise (NO), control is passed to step S311.

In step S318, the data area in which a schedule is registered is deleted from the storage device, and then control is passed to step S324.

In step S319, the speech recognizing process of recognizing a schedule retrieve command (for example, “schedule retrieval”) which is a registered word is performed on the speech detected by the microphone 53, and it is determined whether or not the schedule retrieve command is contained in the speech. If a schedule retrieve command is contained (YES), then control is passed to step S320. Otherwise (NO), control is passed to step S303.

In step S320, the message requesting to utter a select large/small item command of the schedule contents is displayed on the LCD display device 62, and the speech detected by the microphone 53 is read, the speech recognizing process of recognizing the select large/small item command of the schedule contents contained in the speech is performed, and the user is allowed to input a large/small item of the schedule contents to be retrieved.

Then, in step S321, the speech recognizing process of recognizing a retrieval execute command (for example, “execute retrieval”) which is a registered word is performed on the speech detected by the microphone 53, and it is determined whether or not the retrieval execute command is contained in the speech. If a retrieval execute command is contained (YES), then control is passed to step S322. Otherwise (NO), control is passed to step S320.

In step S322, the schedule corresponding to the large/small item of the schedule contents recognized in step S320 is retrieved from a predetermined data area of the storage device, and a retrieval result is displayed on the LCD display device 62.

In step S323, the speech recognizing process of recognizing a re-retrieve command (for example, “re-retrieval”) which is a registered word is performed on the speech detected by the microphone 53, and it is determined whether or not the re-retrieve command is contained in the speech. If a re-retrieve command is contained (YES), then control is passed to step S324. Otherwise (NO), control is passed to step S320.

In step S324, the speech recognizing process of recognizing a terminate command (for example, “terminate”) which is a registered word is performed on the speech detected by the microphone 53, and it is determined whether or not the terminate command is contained in the speech. If a terminate command is contained (YES), then the process terminates. Otherwise (NO), control is passed to step S303.

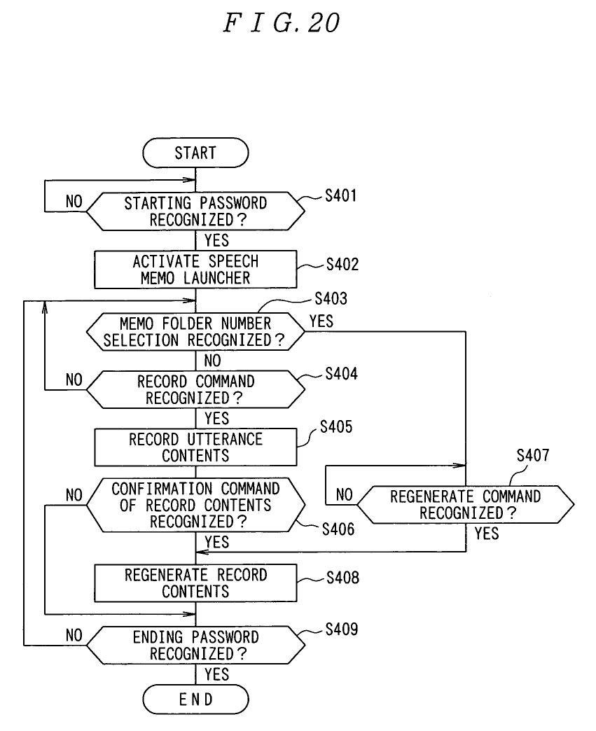

FIG. 20 shows the process performed by the information terminal shown in FIG. 13, and is a flowchart of the arithmetic process of performing the speech memo function depending on the speech of a user. In this flowchart, no steps are provided for communications. However, the information obtained in the arithmetic process is updated and stored in the storage device at anytime, and necessary information is read from the storage device. When the arithmetic process is performed, first in step S401, the speech detected by the microphone 53 is read, and the speech recognizing process of recognizing whether a starting password (for example, “speech memo”) which is a registered word contained in the speech is contained, or noise or speech other than a starting password, that is, only unnecessary words are contained is performed. If a starting password is contained (YES), then control is passed to step S402. Otherwise (NO), the process flow is repeated.

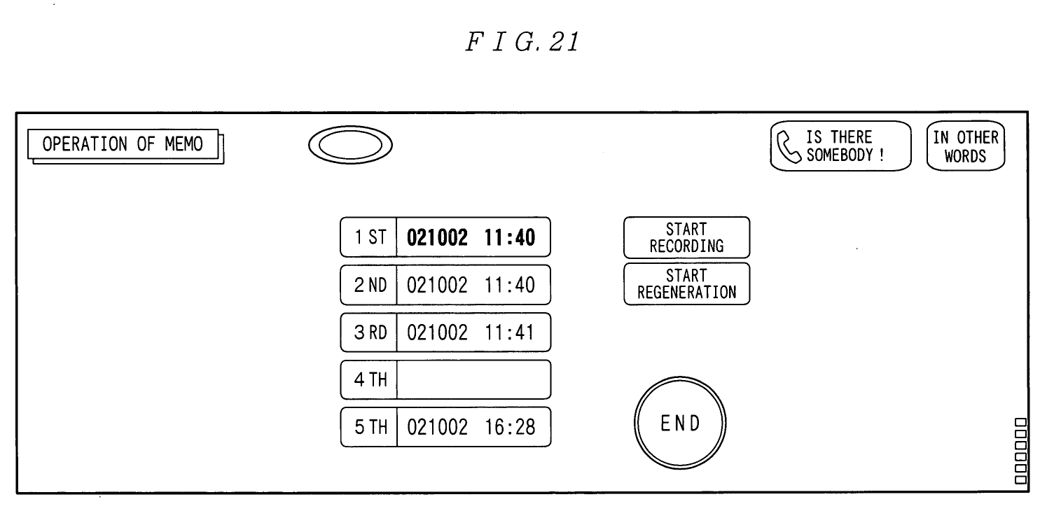

Then, in step S402, a speech memo vocabulary list is read as a registered vocabulary list, and the speech memo launcher is activated as shown in FIG. 21, and a list of registered words with which a user can issue an instruction is displayed on the LCD display device 12. The registered words to be displayed on the LCD display device 62 can be: a record command (for example, “start record”) to be uttered when speech is to be recorded; a regenerate command (for example, “start regeneration”) to be uttered when a speech memo is to be regenerated; a memo folder number select command, the number associated with each speech memo, (for example, “first”, “second”, etc.), etc. to be uttered when a speech memo is to be selected.

In step S403, the speech recognizing process of recognizing a memo folder number select command which is a registered word is performed on the speech detected by the microphone 53, and it is determined whether or not the memo folder number select command is contained in the speech. If a memo folder number select command is contained (YES), then control is passed to step S404. Otherwise (NO), control is passed to step S407.

In step S404, the speech recognizing process of recognizing a record command which is a registered word is performed on the speech detected by the microphone 53, and it is determined whether or not the record command is contained in the speech. If a record command is contained (YES), then control is passed to step S405. Otherwise (NO), control is passed to step S403.

In step S405, a message requesting to utter the memo contents is displayed on the LCD display device 62, speech data is generated by recording speech detected by the microphone 53 for a predetermined time, and the speech data is stored in a predetermined data area in the storage device as memo contents corresponding to the memo folder selected in step S403.

In step S406, the speech recognizing process of recognizing a record contents confirm command (for example, “confirm”) which is a registered word is performed on the speech detected by the microphone 53, and it is determined whether or not the record contents confirm command is contained in the speech. If a record contents confirm command is contained (YES), then control is passed to step S408. Otherwise (NO), control is passed to step S409.

In step S407, the speech recognizing process of recognizing a regenerate command which is a registered word is performed on the speech detected by the microphone 53, and it is determined whether or not the regenerate command is contained in the speech. If a regenerate command is contained (YES), then control is passed to step S408. Otherwise (NO), the process flow is repeated.

In step S408, the speech data corresponding to the memo folder selected in step S403, that is, the memo contents, is read from a predetermined data area of the storage device, and the speech data is regenerated by the speaker 67, and control is passed to step S409.

In step S409, the speech recognizing process of recognizing a terminate command (for example, “terminate”) which is a registered word is performed on the speech detected by the microphone 53, and it is determined whether or not the terminate command is contained in the speech. If a terminate command is contained (YES), then the process terminates. Otherwise (NO), control is passed to step S403.

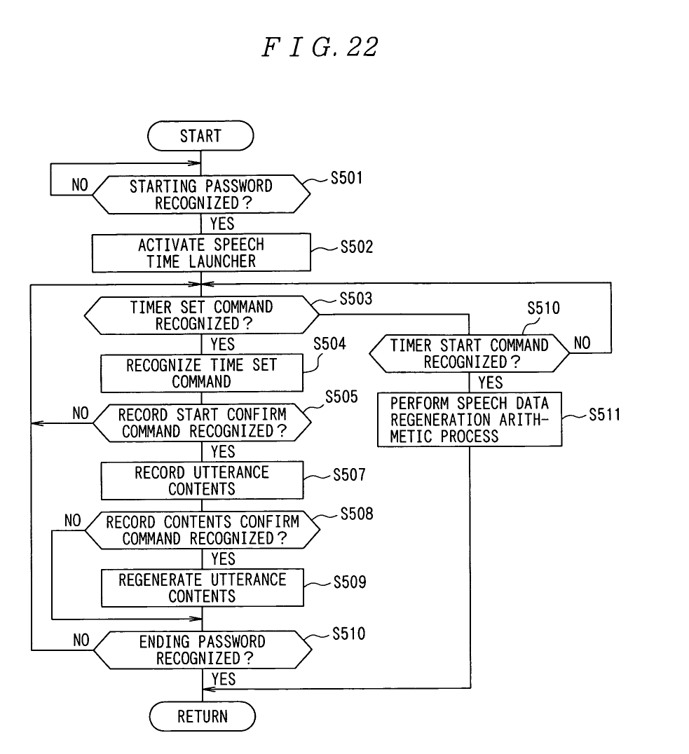

FIG. 22 shows the process performed by the information terminal shown in FIG. 13, and is a flowchart of the arithmetic process of performing the speech timer function depending on the speech of a user. In this flowchart, no steps are provided for communications. However, the information obtained in the arithmetic process is updated and stored in the storage device at anytime, and necessary information is read from the storage device. When the arithmetic process is performed, first in step S501, the speech detected by the microphone 53 is read, and the speech recognizing process of recognizing whether a starting password (for example, “speech timer”) which is a registered word contained in the speech is contained, or noise or speech other than a starting password, that is, only unnecessary words are contained is performed. If a starting password is contained (YES), then control is passed to step S502. Otherwise (NO), the process flow is repeated.

Then, in step S502, a speech timer vocabulary list is read as a registered vocabulary list, and the speech timer launcher is activated, and a list of registered words with which a user can issue an instruction is displayed on the LCD display device 12. The registered words to be displayed on the LCD display device 62 can be: a timer set command (for example, “set timer”) to be uttered when notice contents and notice timing are set, a timer start command (for example, “start timer”) to be uttered when a timer is operated, etc.

In step S503, the speech recognizing process of recognizing a timer set command which is a registered word is performed on the speech detected by the microphone 53, and it is determined whether or not the timer set command is contained in the speech. If a timer set command is contained (YES), then control is passed to step S504. Otherwise (NO), control is passed to step S502.

In step S504, a message requesting to input the time from the start of the operation of the timer to the notice, that is, the notice timing, is displayed on the LCD display device 62, the speech detected by the microphone 53 is read, and the speech recognizing process of recognizing the timer time set command (for example, “minutes”) which is a registered word is performed.

Then, in step S505, a message requesting to return an answer as to whether or not the notice contents are to be recorded is displayed on the LCD display device 62, the speech recognizing process of recognizing a record start confirm command (for example, “Yes”) which is a registered word is performed on the speech detected by the microphone 53, and it is determined whether or not the record start confirm command is contained in the speech. If a record start confirm command is contained (YES), then control is passed to step S506. Otherwise (NO), control is passed to step S502.

In step S506, the message requesting to utter the notice contents is displayed on the LCD display device 62, the speech data is generated by recording the speech detected by the microphone 53 for a predetermined time, and the speech data is stored in a data area of the storage device as notice contents to be announced at a time recognized in step S504, that is, with a notice timing.

Then, in step S507, the speech data recorded in step S506, that is, the message requesting to confirm the notice contents, is displayed on the LCD display device 62, the speech recognizing process of receiving a confirm command of the record contents which is a registered word is performed on the speech detected by the microphone 53, it is determined whether or not the speech contains the confirm command of the record contents. If the confirm command of the record contents is contained (YES), then control is passed to step S508. Otherwise (NO), control is passed to step S509.

In step S508, the speech data generated in step S506, that is, the notice contents, is regenerated by the speaker 67, and then control is passed to step S509.

In step S509, the speech recognizing process of recognizing a terminate command (for example, “terminate”) which is a registered word is performed on the speech detected by the microphone 53, and it is determined whether or not the terminate command is contained in the speech. If a terminate command is contained (YES), then the arithmetic process terminates. Otherwise (NO), control is passed to step S502.

In step S510, the speech recognizing process of recognizing a timer start command which is a registered word is performed on the speech detected by the microphone 53, and it is determined whether or not the timer start command is contained in the speech. If a timer start command is contained (YES), then control is passed to step S511. Otherwise (NO), control is passed to step S502.

In step S511, the speech data generated in step S506, that is, the notice contents, are read from a predetermined data area of the storage device at a time recognized in step S504, that is, with a notice timing, the arithmetic process of regenerating the speech data by the speaker 67 is performed, and the arithmetic process is terminated.

As explained above, since the information communications terminal according to the present embodiment performs the electronic mail transmitting and receiving function, the schedule managing function, the speech memo processing function, and the speech timer function by recognizing the registered word contained in the speech of a user, the user can use each function only by uttering the registered word without physical operations.

Furthermore, since the speech recognizing process similar to the process in the above-mentioned first embodiment is performed, as in the first embodiment, when speech containing no registered words, that is, speech other than the registered words, are uttered by a user, the likelihood of the virtual model 23 is calculated large for the acoustic parameter series of the speech, and the likelihood of the vocabulary network 22 of registered words is calculated small. Based on the likelihoods, the speech other than the registered word is recognized as an unnecessary word, and the speech other than the registered word is prevented from being misrecognized as a registered word, thereby avoiding a malfunction of the information terminal.

According to the present invention, the microphone 53 corresponds to the speech detection means, the speech instruction recognition circuit 56 corresponds to the speech recognition means, and the central control circuit 58 corresponds to the control means.

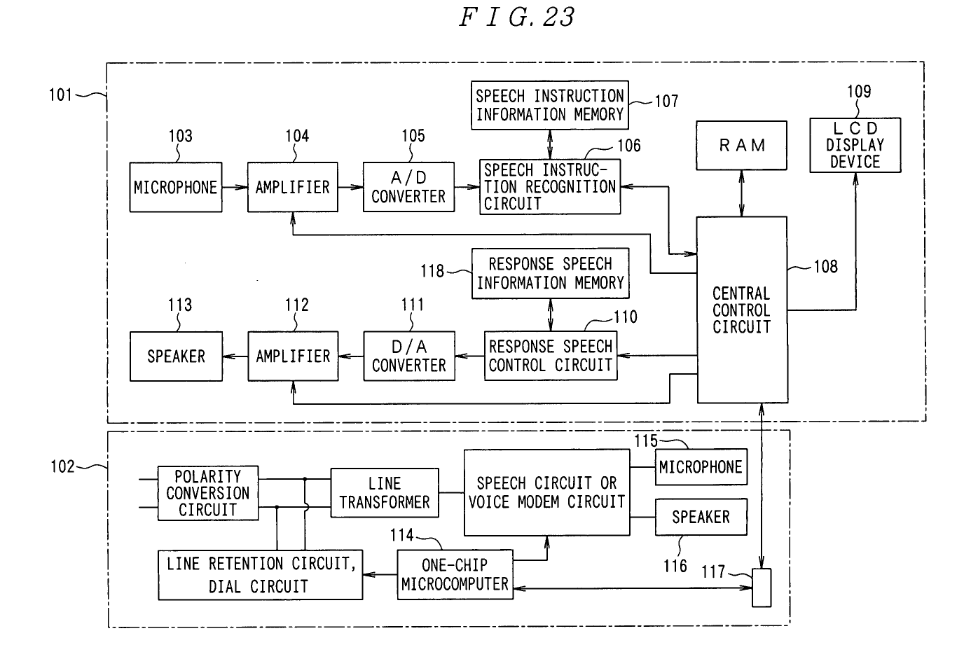

The third embodiment of the present invention is described below by referring to the attached drawings. In this embodiment, the speech recognizing process similar to the process in the first embodiment is applied to the telephone communication terminal for connection to a communications circuit by recognizing the registered word contained in the speech of a user. FIG. 23 is a primary block diagram of the telephone communication terminal using an analog telephone or a voice modem according to the third embodiment of the present invention. The telephone communication terminal shown in FIG. 23 comprises a speech recognition unit 101 for controlling speech recognition; a speech communications unit 102 for controlling speech communications, that is, the speech recognition unit 101 for recognizing a registered word contained in the speech of a user, and a speech communications unit 102 for connection to a communications circuit based on the recognition result. The speech of a user is input from a microphone 103 of the speech recognition unit 101, transmitted through an amplifier 104, and converted by an A/D converter 105 into a digitized acoustic parameter. The input analog speech is not designated, but is normally sampled and digitized at a specific frequency in the range from 8 KHz to 16 KHz. The likelihood of the digitized acoustic parameter is calculated relative to the acoustic parameter for each speech unit which is a configuration unit of each word for the registered vocabulary list stored and registered in speech instruction information memory 107 in a speech instruction recognition circuit 106, thereby extracting the most likely word from the registered vocabulary list. That is, in the speech instruction recognition circuit 106, the likelihood of a word (hereinafter referred to as a registered word) in the registered vocabulary list stored and registered in the speech instruction information memory 107 for the digitized acoustic parameter is calculated for each configuration unit (hereinafter referred to as a speech unit), and the largest accumulation value of the likelihood is extracted as the registered word closest to the speech of the user. In the speech instruction recognition circuit 106, the likelihood of the unnecessary word model stored and registered in the speech instruction information memory 107 is simultaneously calculated for the digitized acoustic parameter. When the likelihood of the unnecessary word model is higher than the likelihood of the registered word, it is assumed that no registered word has been extracted from the digitized acoustic parameter.

In the registered vocabulary list, registered words and unnecessary words other than the registered words are registered. A speech unit can be a syllable, a phoneme, a semisyllable, a diphone (two pairs of phoneme), a triphone (three pairs of phoneme), etc.

In the speech instruction information memory 107, a name vocabulary list storing names and the phone numbers corresponding to the names, a number vocabulary list for recognition of serial numbers depending on the number of digits corresponding to an arbitrary phone number, a telephone call operation vocabulary list relating to the telephone operation, a call receiving operation vocabulary list relating to the response when an incoming call is received, and a control code corresponding to each registered word are stored as registered vocabulary lists. For example, when the speech instruction recognition circuit 106 extracts a registered word relating to the telephone operation, that is, a recognition result is obtained, the control code for the telephone operation corresponding to the speech recognized registered word is called from the speech instruction information memory 107, and transmitted from a central control circuit 108 to the speech communications unit 102. The control code is not specified so far as it is used in control the speech communications unit 102. However, since an AT command is generally used, the AT command is adopted as a representative example in the present embodiment.

In a phone call operation, when a name of a person or phone number information is input by speech from the microphone 103, a registered word contained in the speech is recognized, the speech recognition result is displayed on the LCD display unit 109 for visual notice, called from a response speech information memory 118 by a response speech control circuit 110, and is aurally announced as an analog signal from a speaker 113. When the recognition result is correct, and when a user input a speech command such as “make a call”, etc. from the microphone 103, the central control circuit 108 converts issue control to a destination phone number as an AT command and transmits it to a one-chip microcomputer 114 of the speech communications unit 102.

When a telephone line is connected and the schedule contents is enabled, speech communications are performed using a microphone 115 and a speaker 116 of the speech communications unit 102, and the volume level of the microphone 103 and the speaker 113 of the speech recognition unit 101 can be adjusted independent of the microphone 115 and the speaker 116 of the speech communications unit 102.

In the speech recognition unit 101, when the control code for control of telephone is transmitted from the central control circuit 108 to the speech communications unit 102 through an external interface 117, the on-hook status, the off-hook status, or the line communications status of the speech communications unit 102 can be checked by receiving a status signal from the speech communications unit 102, and the misrecognition due to an unnecessary word can be reduced by sequentially changing necessary registered vocabulary lists for the subsequent operations depending on the status. For example, when an incoming call is received, ringing information for announcement of a call received at the speech communications unit 102 is transmitted to the speech recognition unit 101, thereby calling a call receiving operation vocabulary list relating to a response to an incoming call, and a determination as to whether or not a user answer the call by speech is input using the microphone 103 of the speech recognition unit 101, and telephone communications can be performed handsfree by speech input. At this time, if the destination information such as the phone number of the destination, etc. can be obtained, then the name and the phone number are compared with the name vocabulary list, the comparison result is displayed on the LCD display unit 109 for visual notice, the response speech data corresponding to the comparison result is called from the response speech information memory 118 using the response speech control circuit 110, and the announcement “a call from Mr. ooo” can be aurally transmitted from the microphone 103 through the D/A converter 111 and the amplifier 112.

Thus, according to the present embodiment, by providing a speech input/output system, that is, at least two systems of a microphone and a speaker, more detailed information can be transmitted to a user by means other than screen display concurrent with the operation of the speaker 116 used in normal ringing system. In a method of transmitting detailed information on the screen display, operations can be smoothly performed even in a case in which it is hard to confirm the destination information about the telephone which receives an incoming call when a user is away from the body of a telephone, when the eyes cannot be changed to the screen while driving a car, or when the user is a visually handicapped person.

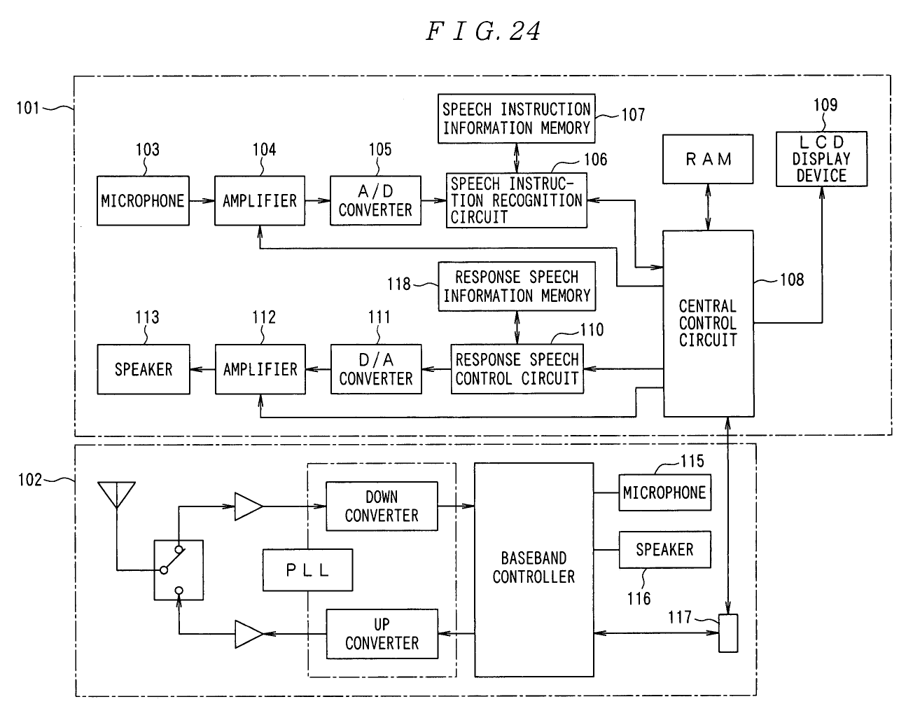

FIG. 24 shows a variation of the wireless system of a mobile telephone as connection means to a public telephone line. As compared with FIG. 23, it is different in the primary block diagram of the speech communications unit 102. When the wireless system of a mobile phone is used, a normal input/output device for speech communications, that is, the microphone 115 and the speaker 116 of the speech communications unit 102, are controlled to be powered on and off according to the speech receiving condition of the destination. Therefore, by separately preparing the speech input/output device, that is, the microphone 103 and the speaker 113 for speech recognition, the telephone communication terminal having the function of speech recognition can be constantly used regardless of the feature (operation status) of the input/output device for speech communications which is operated depending on the speech communications system. That is, although a user is communicating with a partner and the microphone 115 and the speaker 115 of the speech communications unit 102 are occupied for the communications, the user can input speech on the speech recognition unit 101, and can control the speech communications unit 102. In the method of inputting speech by a hand set with a dial signal automatically transmitted by speech, an off-hook mode is required as a telephone capability to constantly accept speech input. In this case, the receiver is constantly off-hook, thereby rejecting an incoming call.

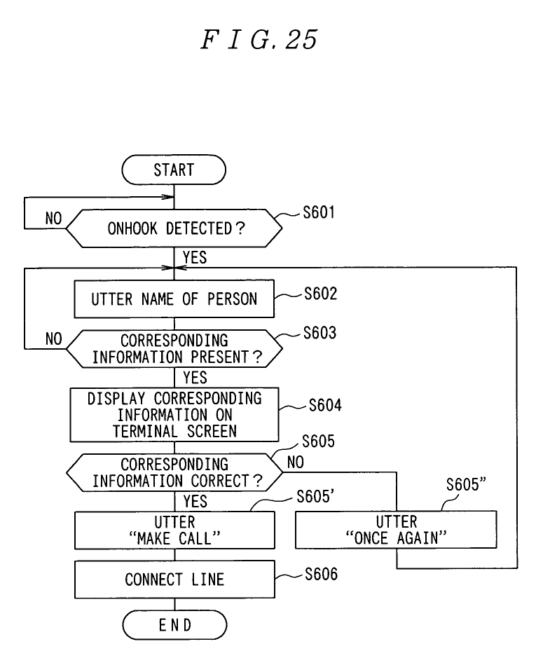

FIG. 25 is a flowchart of the arithmetic process of an issuing operation, etc. performed by the central control circuit 108 by a user uttering the name of a person. That is, FIG. 25 shows the process scheme relating to a call issuing operation using the name of a person. In this flowchart, although there is no step for communications, the information obtained in the arithmetic process is updated and stored in the storage device at any time, and necessary information is read from the storage device. When the arithmetic process is performed, first in step S601, the initial status of the speech communications unit 102 is confirmed by detecting the on-hook status, and the status of accepting an issue of a call. Practically, it is determined whether or not it is on-hook status by receiving a status signal from the speech communications unit 102. If it is on-hook status (YES), then control is passed to step S602. Otherwise (NO), the process flow is repeated.

In step S602, the input of a name by speech from a user is received. Practically, as a registered vocabulary list, a name vocabulary list storing the names and phone numbers is read, the speech detected by the microphone 103 is read, and the speech instruction recognition circuit 106 recognizes whether or not the speech contains the name registered in the registered vocabulary list, or contains noise and speech other than the names of persons, that is, unnecessary words only. Relating to the name of a person, the speech instruction information memory 107 stores a phone number corresponding to the name as a name vocabulary list. Input analog speech is not specifically limited, but is normally sampled and digitized at a specific frequency in the range from 8 KHz to 16 KHz. The likelihood of the digitized acoustic parameter is calculated relative to the acoustic parameter for each speech unit which is a configuration unit of each word for the registered name vocabulary list stored and registered in speech instruction information memory 107 in the speech instruction recognition circuit 106, thereby extracting the most likely word from the registered name vocabulary list. That is, in the speech instruction recognition circuit 106, the likelihood of a name in the name registered vocabulary list and stored and registered in the speech instruction information memory 107 for the digitized acoustic parameter is calculated for each configuration unit in the speech instruction recognition circuit 106, and the largest accumulation value of the likelihood is extracted as the registered name closest to the speech of the user. In the speech instruction recognition circuit 6, the likelihood of the unnecessary word model stored and registered in the speech instruction information memory 7 is simultaneously calculated for the digitized acoustic parameter. When the likelihood of the unnecessary word model is higher than the likelihood of the registered name, it is assumed that no registered name has been extracted from the digitized acoustic parameter.

In step S603, it is determine whether or not it is recognized in step S602 that the name of a person registered in the name vocabulary list is contained in the speech. If the name of a person registered in the registered vocabulary list is contained (YES), then control is passed to step S604. Otherwise (NO), control is passed to step S602.

In step S604, when the name of a person is extracted in step S602, the extracted name is displayed on the terminal screen (LCD display unit 109) connected to the speech communications unit 102, and the extracted name is announced by speech announcement through the response speech control circuit 110.

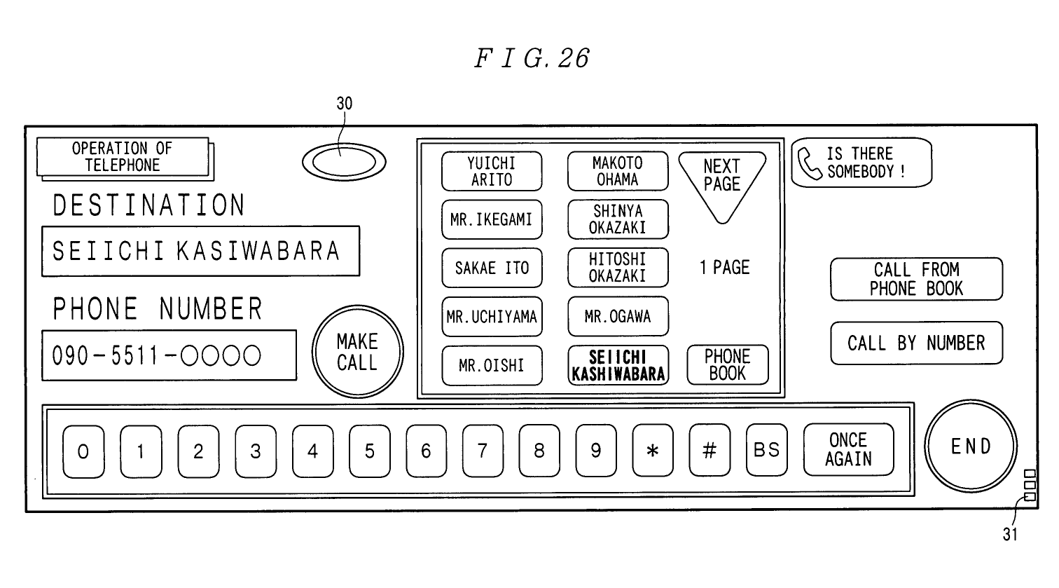

Then, control is passed to step S605. As shown in FIG. 26, first, a word indicating the process to be performed or a message requesting to utter a word indicating the process to be performed again is displayed on the LCD display unit 109. Then, the speech detected by the microphone 103 is read, and the speech instruction recognition circuit 106 recognizes whether the word indicating the process to be performed which is a registered word is contained in the speech, or whether or not the word indicating that the process is to be performed again is contained in the speech. Then, it is determined whether or not the speech detected by the microphone 103 contains a word indicating the process to be performed which is a registered word, or a word indicating the process to be performed again. If it contains a word indicating the process to be performed (YES), then control is passed to step S606. Otherwise (NO), control is passed to step S602. The user determines whether or not the extracted name is a desired result. If it is a desired result, then a word indicating the process registered in advance such as “make a call”, etc. is uttered, and the speech instruction recognition circuit 106 performs the process of recognizing an input speech command.

In step S606, the phone number corresponding to the name of a person extracted in step S602 is read from the name vocabulary list, the AT command corresponding to the phone number is called from the speech instruction information memory 107, and the AT command is transmitted to the speech communications unit 102. Then, as described above, if the word is recognized as a word “make a call” registered in advance, the AT command (ATD) for issue of a corresponding phone number is transmitted from the central control circuit 108 to the speech communications unit 102, and the process of a line connection is performed. If the off-hook status of the communications partner is in response to a calling tone, the line connection is completed, and the speech communication is performed.

On the other hand, if the extracted name is not desired, a speech command indicating a process to be performed again, for example, “once again” is uttered, and the speech input in the speech instruction recognition circuit 106 is recognized. As described above, if a word as “once again” registered in advance is recognized, control is returned to a step (S602) of accepting the utterance of the name of a person, and the system enters the status in which a new name of a person is accepted.

FIG. 7 shows an example of the speech recognizing process performed by the speech instruction recognition circuit 106. The process of the speech recognizing process is not specifically designated. However, according to the present embodiment, as in the first embodiment, the process using a hidden Markov model (hereinafter referred to as an HMM for short) is used. When the speech recognizing process is performed, first the speech detected by the microphone 103 is converted into a digitized spectrum in a Fourier transform or a wavelet transformation, and the speech data is characterized using a speech modeling method such as a linear predication analysis, a cepstrum analysis, etc. on the spectrum. Then, for the characterized speech data, the likelihood of an acoustic model 121 of each word registered in a vocabulary network 120 read in the speech recognizing process in advance is calculated using the Viterbi algorithm. The registered word is modeled in a serial connection network of the HMM corresponding to a serial connection (speech unit label series) in a speech unit, and the vocabulary network 120 is modeled as a serial connection network corresponding to a registered word group registered in the registered vocabulary list. Each registered word is configured in a speech unit of a phoneme, etc., and the likelihood is calculated for each speech unit. When the termination of utterance of a user is checked, the registered word having the largest accumulation value of likelihood is detected from the registered vocabulary list, and the registered word is output as a registered word recognized as contained in the speech.

Furthermore, as in the first embodiment, the virtual model 23 for recognition of an unnecessary word is provided parallel to the vocabulary network 120 of registered words. With the configuration, when speech and noise not containing a registered word, that is, an unnecessary word, is input as speech, the likelihood of the virtual model 23 corresponding to the unnecessary word is calculated larger than the likelihood of the registered word, and it is determined that an unnecessary word has been input, thereby avoiding the misrecognition of utterance, etc. containing no registered word as a registered word.

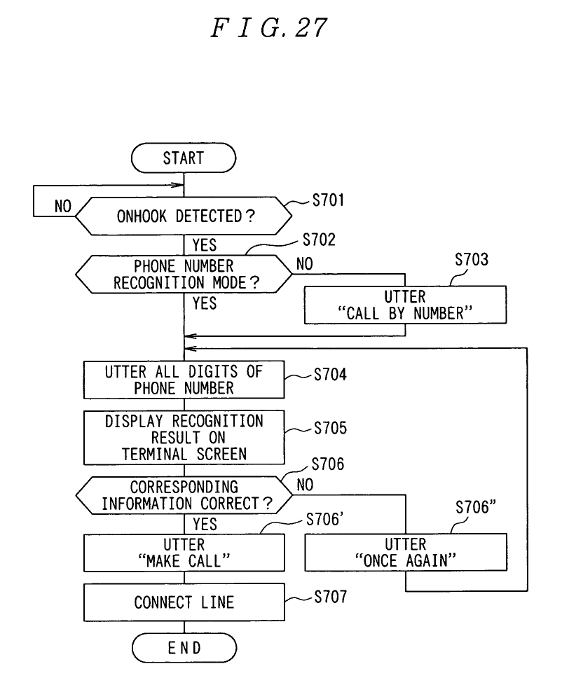

FIG. 27 is a flowchart of the arithmetic process of an issuing operation, etc. performed by the central control circuit 108 by a user uttering a phone number. That is, FIG. 27 shows the process scheme relating to a call issuing operation using a phone number. In this flowchart, although there is no step for communications, the information obtained in the arithmetic process is updated and stored in the storage device at anytime, and necessary information is read from the storage device. When the arithmetic process is performed, first in step S701, the initial status of the speech communications unit 102 is confirmed by detecting the on-hook status, and the status of accepting an issue of a call. Practically, it is determined whether or not it is on-hook status by receiving a status signal from the speech communications unit 102. If it is on-hook status (YES), then control is passed to step S702. Otherwise (NO), the process flow is repeated.

In step S702, it is determined whether or not a phone number confirmation mode for accepting an arbitrary phone number is entered. If the mode is entered (YES), then control is passed to step S704. Otherwise (NO), then control is passed to step S703.

In step S703, the speech detected by the microphone 103 is read, the speech instruction recognition circuit 106 recognizes that a speech command registered in advance for reception of a phone number which is a registered word contained in the speech is contained. If the speech command is recognized, control is passed to step S704. Then, the user confirms whether or not it is the phone number recognition mode for reception of an arbitrary phone number. If it is a name recognition mode, etc. other than the phone number recognition mode, then a speech command registered in advance for reception of a phone number is uttered.

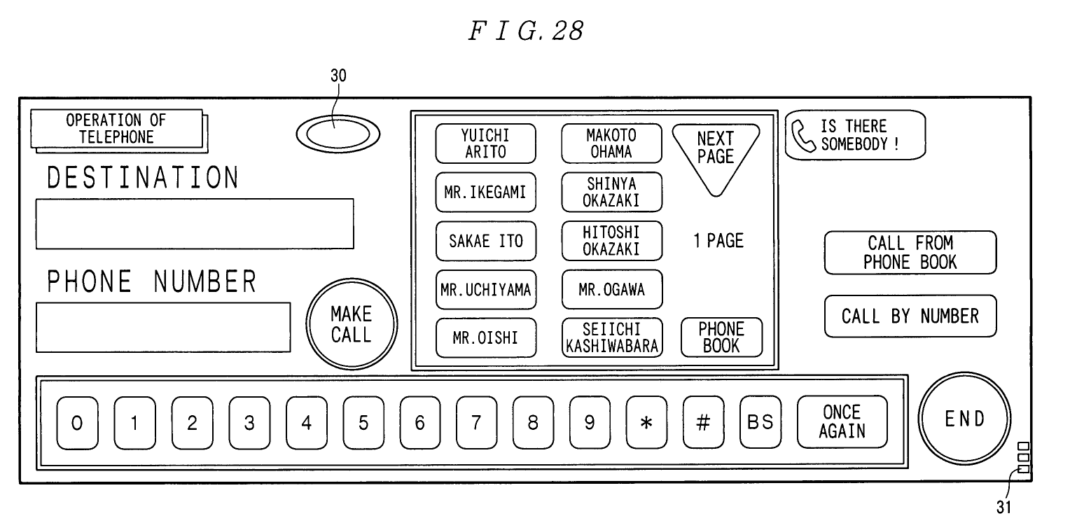

In step S704, a number vocabulary list for recognition of a series of numbers depending on the number of digits corresponding to an arbitrary phone number is first called as a registered vocabulary list. Next, as shown in FIG. 28, a message requesting to utter a phone number is displayed on the LCD display unit 109. The speech detected by the microphone 103 is read, and the speech instruction recognition circuit 106 recognizes whether or not a series of numbers which are registered words contained in the speech are contained. For example, “phone call by number” is a speech command registered for acceptance of the phone number. When the user utters “phone call by number”, the speech instruction recognition circuit 106 recognizes the input speech through the microphone 103. If “phone call by number” is recognized, the speech instruction recognition circuit 106 uploads a number vocabulary list for recognition of any phone number in the memory of a speech instruction recognition circuit, thereby entering the phone number acceptance mode. The user continuously utters a desired phone number such as “03-3356-1234” (−is not uttered) for speech recognition.

The number vocabulary list for recognition of any phone number refers to some patterns formed by a series of character strings depending on the nations, and areas in which phones are used, the phone communications system, the nation and the area of the communication partner. For example, when a call is made from Japan to predetermined telephone models, the pattern is represented by “0-inter-city number-intra-city number-subscriber number”, that is, a total of 10 digits (9 digits in a specific areas) of serial numbers forming a number vocabulary list. Between the inter-city number and the intra-city number, or between the intra-city number and the subscriber number, “no” and a speech unit indicating a space can be inserted so that the redundancy of a uttering user who utters a phone number can be amended.

When a call is made from Japan to a mobile phone or PHS in Japan, a vocabulary list formed by a series of 11 digits of numbers starting with “0A0 (A indicates a single number other than 0)” is prepared. In addition, there also is a dedicated number vocabulary list formed by a number strings according to a numeral strings indicated for each common carrier prepared by the Ministry of General Affairs. Table 2 lists a phone number patterns in Japan published by the Ministry.

As described above, according to the present invention, when a phone number is recognized, a user only has to continuously utter a number string corresponding to the entire digits of a phone number, thereby recognizing a phone number in a short time. In the method of recognizing a phone number digit by digit, a long time is required to correctly recognize all digits.

TABLE 2

| Number pattern | Class of destination |
|---|---|
| Number starting with 00 | When a call is made through a common |
| | carrier, or when an international call |
| | is made |
| Number starting with 0A0 | When a call is made to a mobile phone, |
| (A is other than 0) | a PHS, a pocket bell for which a call |
| | issuer takes charge |
| Number starting with 0AB0 | When a high quality phone service |
| (A and B are other than 0) | provided by a common carrier is used |
| Phone number starting with | When a call is made to a common fixed |
| OABC (A, B, and C are other | type telephone (inter city |
| than 0) | communications) |
| | (0 - inter-city number - intra-city |
| | number - subscriber number) |
| Number starting with 1 | When a call service has a value added |
| | and is important as an emergency |
| | service, a common service, a security |
| | service, etc. |
| Number starting with 2-9 | When a call is made to a common fixed |
| | type telephone (intra-city |
| | communications) |

The method of allocating each number vocabulary list to the speech instruction recognition circuit 106 is appropriately used depending on the recognition precision of a speech recognition engine used by the speech instruction recognition circuit 106. One of the methods is to dynamically determine a pattern of a numeral string (3 to 4 digits) recognized from the head of the numeral string when it is input by speech by the microphone 103, and dynamically allocate the pattern to a number vocabulary list selected when the pattern is recognized. In this method, for example, when a number “0 (zero)” is recognized between the first and third digits in the first 3-digit number string, it is considered in Japan to be the pattern of a phone number of a mobile phone, a PHS, etc., and a number vocabulary list for recognition of a 8-digit number string (a total of 11 digits) or a specific number string is allocated.

In another method, all number vocabulary lists are statically read to the speech instruction recognition circuit 106, a likelihood indicating the adaptivity to a specific number is calculated as an average value variable with time from the head of the phone numbers input by users. Thus, several probable patterns are left as prospects, and other patterns are removed from the arithmetic operation. Finally, when the utterance section is detected, the pattern having the highest likelihood is obtained, and the likely number is determined. In these methods, a pattern is selected from among an enormous number of probable number strings, the recognition precision can be improved, and the load of arithmetic operation required in recognition can be reduced, thereby continuously recognizing the uttered numbers as a phone number.

In step S705, the phone number recognized in step S704 is displayed on the LCD display unit 109, the recognition result is transmitted to the response speech control circuit 110, and the phone number is announced to the A/D converter 105.

Then, control is passed to step S706. First, a word indicating the process to be performed or a message requesting to utter a word indicating the process to be performed again is displayed on the LCD display unit 109. Then, the speech detected by the microphone 103 is read, and the speech instruction recognition circuit 106 recognizes whether the word indicating the process to be performed which is a registered word contained is contained in the speech, or whether or not the word indicating that the process is to be performed again is contained in the speech. Then, it is determined whether or not the speech detected by the microphone 103 contains a word indicating the process to be performed which is a registered word, or a word indicating the process to be performed again. If it contains a word indicating the process to be performed (YES in step S706′), then control is passed to step S707. Otherwise (NO in step S706″), control is passed to step S704.

In step S707, the AT command corresponding to the phone number extracted in step S704 is called from the speech instruction information memory 107, and the AT command is transmitted to the speech communications unit 102.

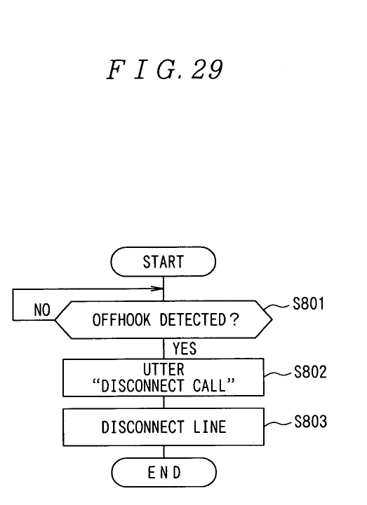

FIG. 29 is a flowchart of the arithmetic process of an off-hook operation, etc. performed by the central control circuit 108 by a user uttering a word indicating the termination of the communications. That is, FIG. 29 shows the process scheme relating to an on-hook operation for termination of communications. In this flowchart, although there is no step for communications, the information obtained in the arithmetic process is updated and stored in the storage device at any time, and necessary information is read from the storage device. When the arithmetic process is performed, first in step S801, the operation status of the speech communications unit 102 is confirmed as a communications mode by detecting the off-hook status. Practically, it is determined whether or not it is off-hook status by receiving a status signal from the speech communications unit 102. If it is off-hook status (YES), then control is passed to step S802. Otherwise (NO), the process flow is repeated.

In step S802, first as registered vocabulary lists, a communications operation vocabulary list in which only necessary speech commands required during communications and when the communications are terminated are registered in advance is read. Then, the speech detected by the microphone 103 is read, and the speech instruction recognition circuit 106 recognizes whether or not the speech command indicating the termination of the communications which is a registered word contained in the speech is contained.

Then, in step S803, an AT command indicating a line disconnection is called from the speech instruction information memory 107, and the AT command is transmitted to the speech communications unit 102. Therefore, if the speech command indicating the termination of communications, for example, “disconnect the line” is uttered by a user, then the speech instruction recognition circuit 106 recognizes input speech through the microphone 103. If “disconnect the line” is recognized, the control code indicating a line disconnection is transmitted to the speech communications unit 102 using the AT command (ATH) from the central control circuit 108, thereby completing the disconnection of a line.

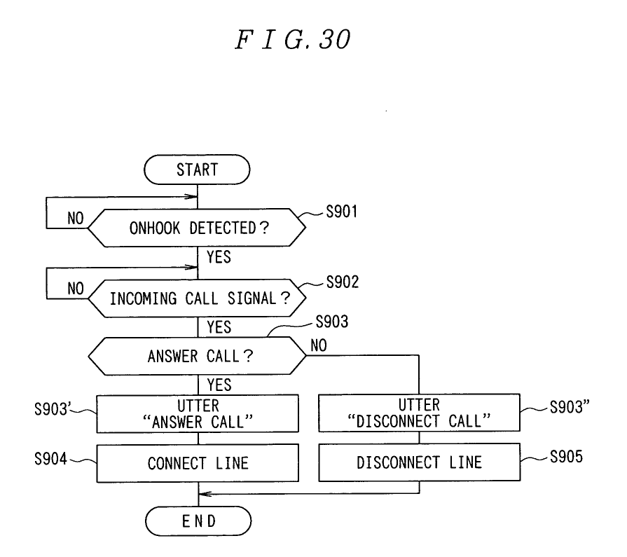

FIG. 30 is a flowchart of the arithmetic process of an off-hook operation, etc. performed by the central control circuit 108 by a user uttering a word indicating an incoming call. That is, FIG. 30 shows the process scheme relating to an off-hook operation for receiving an incoming call. In this flowchart, although there is no step for communications, the information obtained in the arithmetic process is updated and stored in the storage device at any time, and necessary information is read from the storage device. When the arithmetic process is performed, first in step S901, the operation status of the speech communications unit 102 is confirmed as a standby status by detecting the on-hook status. Practically, it is determined whether or not it is on-hook status by receiving a status signal from the speech communications unit 102. If it is on-hook status (YES), then control is passed to step S902. Otherwise (NO), the process flow is repeated.

In step S 902, it is determined whether or not a result code indicating an incoming call has been received from the speech communications unit 102. If the result code has been received (YES), a message announcing that a call reception signal has been received is displayed on the LCD display unit 109, and the message is transmitted to the response speech control circuit 110, the message is announced by the A/D converter 105, then control is passed to step S903. Otherwise (NO), the process flow is repeated. That is, if the speech communications unit 102 receives a signal announcing the reception of an incoming call, it transmits to the central control circuit of the speech recognition unit the result code indicating the reception of the incoming call. Upon receipt of the incoming call signal, the speech recognition unit displays on the LCD display unit 109 the contents announcing the reception of the incoming call signal, and simultaneously allows the speaker 1 to announce the reception of an incoming call by speech. At this time, if the incoming call signal contains destination information, then the information is compared with the destination registered in the name vocabulary list. If matching result is output, it is possible to display by speech and on the screen display more detailed information to the user about “a call from Mr. au ”, etc.

Additionally, the destination information can be stored in memory, and can be announced “The phone number is to be recorded?”, etc., the words relating to the speech instruction registered in advance such as “new registration”, “added registration”, etc. are instructed to be uttered, and new destination data is registered by speech in the name vocabulary list.

In step S903, a call receiving operation vocabulary list relating to the response to an incoming call is read to the speech instruction recognition circuit 106 as a registered vocabulary list. Then, the LCD display unit 109 displays a message requesting to utter a word indicating off-hook, or a word indicating on-hook. In addition, the speech detected by the microphone 103 is read, and the speech instruction recognition circuit 106 recognizes whether or not the word indicating the off-hook which is a registered word contained in the speech is contained. Then, it is determined whether of not the speech detected by the microphone 103 contains a word indicating the off-hook which is a registered word is contained, or whether or not a word indicating on-hook is contained. If a word indicating off-hook is contained (YES in step S903′), control is passed to step S904. If a word indicating on-hook is contained (NO in step S903″), then control is passed to step S905. That is, the speech instruction recognition circuit 106 reads the call receiving operation vocabulary list relating to the response when an incoming call is received, and the user determines whether or not the call is to be answered depending on the situation. When the call is answered, a word indicating off-hook and registered in advance, for example, a word “answer the phone” is uttered. If it is determined by the speech instruction recognition circuit whether or not the speech input through the microphone 103 is “answer the phone”.

In step S904, the AT command indicating off-hook is called from the speech instruction information memory 107, and the AT command is transmitted to the speech communications unit 102. That is, when the recognition result “answer the phone” is obtained, the AT command (ATA) indicating the off-hook is transmitted from the central control circuit 108 to the speech communications unit, the communications mode is entered, and the speech communications are performed using the microphone 2 and the speaker 2.

On the other hand, in step S 905, the AT command indicating on-hook is called from the speech instruction information memory 107, and the AT command is transmitted to the speech communications unit 102. That is, when the user does not want to answer the call, a word indicating a line disconnection and registered in advance, for example, “disconnect the line” is to be uttered. It is recognized and determined by the speech instruction recognition circuit as to whether or not the speech input through the microphone 103 is “disconnect the line”. If the recognition result of “disconnect the line” is obtained, then the AT command (ATH) indicating a line disconnection is transmitted from the central control circuit to the speech communications unit, thereby disconnecting the incoming call signal.

When the frequency of ringing reaches a predetermined value by the initialization of the speech recognition unit, a control code of off-hook is automatically issued, or a control code for an answering phone mode is issued. Thus, a user-requested mode can be entered.

In a series of speech recognizing operations described above, the telephone communication terminal having the speech recognizing function according to the present invention has the speech instruction recognition circuit 106 in which speech detection algorithm (VAD) constantly operates regardless of the presence/absence of speech input. Based on the VAD, the determination is repeated as to whether all sounds including the noise input through the microphone 103 refer to a non-input status, a speech-being-input status, or a speech-completely-input status.

Since the speech instruction recognition circuit 106 constantly operates the speech recognition algorithm, unnecessary sounds and words for speech recognition can be easily input. Therefore, there are rejection functions to avoid malfunctions by correctly recognizing these unnecessary word words and sounds. A method for recognizing unnecessary word words can be a garbage model method, etc. proposed by H. Boulard, B. Dhoore and J. M. Boite, “Optimizing Recognition and Rejection Performance in Wordspotting Systems,” Proc. ICASSP, Adelaide, Australia, pp.I-373-376, 1994, etc.

As shown in FIG. 28, depending on the three status of the internal process of the VAD, that is, when speech is in a non-input status, a timing notice image 30 is expressed in green, when the speech is in a speech-being-input status, it is expressed in yellow, and when the speech is in a speech-completely-input status, it is expressed in red. The timing notice image 30 is displayed at the upper portion of the LCD display unit 109. Simultaneously, a level meter 31 is displayed on the right end of the LCD display unit 109. The level meter 31 extends upwards depending on the size of the speech detected by the microphone 103. That is, the value of the level meter 31 grows with the volume of the speech. Then, the three status of the internal process of the above-mentioned VAD, that is, the timing notice image 30, is displayed on the LCD display device 62 of the speech recognition unit 101, and the timing of the start of the utterance is announced to the user. As a result, unnecessary sounds and words can be discriminated from the necessary utterance, and the level of the speech detected by the microphone 103 can be announced by the level meter 31. Thus, the user can be supported by an appropriate level of the volume. As a result, a registered word can be more easily recognized.

According to the present invention, the microphone 103 and the speaker 113 of the speech recognition unit 101, the microphone 115 and the speaker 116 of the speech communications unit 102 correspond to the speech input/output means, the speech indication recognition circuit 106 corresponds to the speech recognition means, the speech instruction information memory 107 corresponds to the storage means, the LCD display unit 109 corresponds to the screen display means, the central control circuit 108 corresponds to the control means, the microphone 103 corresponds to the speech detection means, the timing notice image 30 corresponds to the utterance timing notice means, and the level meter 31 corresponds to the volume notice means.

The above-mentioned embodiments are only the examples of the speech recognition method, the remote controller, the information terminal, the telephone communication terminal, and the speech recognizer according to the present invention, and do not limit the configuration, etc. of the apparatus.

For example, in the above-mentioned embodiments, the remote controller, the information terminal, and the telephone communication terminal are individually formed, but they are not limited to these applications. For example, the remote controller body 1 according to the first embodiment or the telephone communication terminal according to the third embodiment of the present invention can be provided with the communications unit 52 according to the second embodiment so that the remote controller body 1 can perform the electronic mail transmitting and receiving function, the schedule managing function, the speech memo processing function, the speech timer function, etc. based on the speech recognition result. With the configuration, as in the second embodiment, a user can use each function only by uttering a registered word without physical operations.

Furthermore, the remote controller body 1 according to the first embodiment is provided with the speech communications unit 102 according to the third embodiment to allow the remote controller body 1 to perform speech recognition, and the telephone operation can be performed based on the speech recognition result. Thus, as in the third embodiment, although a user is communicating with a partner and the microphone 115 and the speaker 115 of the speech communications unit 102 are occupied by the communications, speech can be input to the remote controller body 1, and the speech communications unit 102 can be controlled.

Furthermore, the remote controller body 1 of the first embodiment can be provided with the communications unit 52 according to the second embodiment and the speech communications unit 102 according to the third embodiment so that the remote controller body 1 can perform speech recognition. Based on the speech recognition result, the telephone operation can be performed. Additionally, based on the speech recognition result, the electronic mail transmitting and receiving function, the schedule managing function, the speech memo processing function, the speech timer function, etc. can be performed. With the configuration, as in the second embodiment, the user can use each function only by uttering a registered word without any physical operation. Furthermore, as in the third embodiment, although a user is communicating with a partner, and the microphone 115 and the speaker 115 of the speech communications unit 102 are occupied by the communications, speech can be input to the remote controller body 1, and the speech communications unit 102 can be controlled.

### INDUSTRIAL APPLICABILITY

As described above, the speech recognition method according to the present invention calculates also the likelihood of the speech unit label series for an unnecessary word other than the registered word in the comparing process using the Viterbi algorithm. If noise caused on normal living conditions, etc. containing no registered words, that is, the speech other than a registered word, is converted into an acoustic parameter series, then the likelihood of the acoustic model corresponding to the speech unit label series about the unnecessary word is calculated with a large resultant value. Based on the likelihood, the speech other than the registered word can be recognized as an unnecessary word, thereby preventing the speech other than the registered word from being misrecognized as a registered word.

Furthermore, since the remote controller according to the present invention recognizes a word to be recognized contained in the speech of a user in the speech recognition method, the utterance other than the word to be recognized or noise, that is, noise caused on normal living conditions can be assigned a high rejection rate. Thus, a malfunction and misrecognition can be avoided.

Additionally, the information terminal according to the present invention recognizes a registered word contained in the speech of a user in the speech recognition method. Therefore, when speech such as noise caused on normal living conditions, etc. containing no registered word, that is, speech other than a registered word, is uttered by a user, the likelihood of the acoustic model corresponding to the speech unit label series about an unnecessary word is calculated large for the acoustic parameter series of the speech. Based on the likelihood, the speech other than the registered word can be recognized as an unnecessary word, thereby preventing the speech other than the registered word from being misrecognized as a registered word, and avoiding a malfunction of the information terminal.

The telephone communication terminal according to the present invention can constantly perform speech recognition. When a call is issued, misrecognition can be reduced with either a keyword representing a phone number or an arbitrary phone number uttered. When a phone number itself is recognized, utterance can be recognized digit by digit without limiting the utterance of a caller in a continuous utterance of numbers. On the receiving side, an off-hook operation can be performed using speech input. Therefore, telephone operations can be performed handsfree in transmitting and receiving a call. That is, since the communications unit and the speech recognition unit has respective and independent input/output systems of communications unit, the speech of a user can be input to the speech recognition unit although the user is communicating with a partner, and the input/output systems of the communications unit are occupied by the communications, and the communications unit can be controlled.

Since the speech recognizer according to the present invention notifies that it is in a state of recognizing a registered word, a user can utter a registered word with an appropriate timing and the registered word can be easily recognized.

Furthermore, since the speech recognizing process similar to that in the first embodiment is used, when speech other than a registered word is uttered from a user as in the first embodiment, the likelihood of the unnecessary word model 23 is calculated large while the likelihood of the vocabulary network 22 of registered words is calculated small. Based on the likelihoods, the speech other than the registered word is recognized as an unnecessary word, the speech other than the registered word is prevented from being misrecognized as a registered word, and a malfunction of the telephone communication terminal can be avoided.

1. A speech recognition method which performs speech recognition by converting input speech of a target person whose speech is to be recognized into an acoustic parameter series, and comparing using a Viterbi algorithm the acoustic parameter series with an acoustic model corresponding to a speech unit label series about a registered word, comprising parallel to a speech unit label series for the registered word a speech unit label series for recognition of an unnecessary word other than a registered word, in which also a likelihood of the speech unit label series is calculated for an unnecessary word other than the registered word in the comparing process using the Viterbi algorithm, thereby successfully recognizing the unnecessary word as an unnecessary word when the necessary word is input as input speech, characterized in that
said acoustic model corresponding to the speech unit label series is an acoustic model using a hidden Markov model, and the speech unit label series for recognition of the unnecessary word is a virtual speech unit model obtained by equalizing all available speech unit models.

2. A speech recognition method which performs speech recognition by converting input speech of a target person whose speech is to be recognized into an acoustic parameter series, and comparing using a Viterbi algorithm the acoustic parameter series with an acoustic model corresponding to a speech unit label series about a registered word, comprising parallel to a speech unit label series for the registered word a speech unit label series for recognition of an unnecessary word other than a registered word, in which also a likelihood of the speech unit label series is calculated for an unnecessary word other than the registered word in the comparing process using the Viterbi algorithm, thereby successfully recognizing the unnecessary word as an unnecessary word when it is input as input speech, characterized in that
said acoustic model corresponding to the speech unit label series is an acoustic model using a hidden Markov model, and the speech unit label series for recognition of the unnecessary word configures a self-loop from an end point to a starting point of a set of phoneme models corresponding to only the phonemes of vowels.

3. A speech recognition method which performs speech recognition by converting input speech of a target person whose speech is to be recognized into an acoustic parameter series, and comparing using a Viterbi algorithm the acoustic parameter series with an acoustic model corresponding to a speech unit label series about a registered word, comprising parallel to a speech unit label series for the registered word a speech unit label series for recognition of an unnecessary word other than a registered word, in which also a likelihood of the speech unit label series is calculated for an unnecessary word other than the registered word in the comparing process using the Viterbi algorithm, thereby successfully recognizing the unnecessary word as an unnecessary word when it is input as input speech, characterized in that
said acoustic model corresponding to the speech unit label series is an acoustic model using a hidden Markov model, and the speech unit label series for recognition of the unnecessary word is a virtual speech unit model obtained by equalizing all available speech unit models provided parallel to a phoneme model configured as a self-loop network of only the phonemes of vowels.

4. A remote controller which remotely controls by speech a plurality of operation targets, comprising: storage means for storing a word to be recognized indicating a remote operation; means for inputting speech uttered by a user; speech recognition means for recognizing the word to be recognized and contained in the speech uttered by a user using the storage means; and transmission means for transmitting an equipment control signal corresponding to a word to be recognized and actually recognized by the speech recognition means, characterized in that the speech recognition method is based on the speech recognition method according to any of claims 1 to 3.

5. The remote controller according to claim 4, further comprising: a speech input unit for allowing a user to perform communications; and a communications unit for controlling the setting state to the communications line based on the word to be recognized by the speech recognition means, characterized in that the speech input means and the speech input unit of the communications unit can be separately provided.

6. The remote controller according to claim 5, further comprising control means for performing at least one of a process of transmitting and receiving mail by speech, a process of managing a schedule by speech, a memo processing by speech, and a notifying process by speech.

7. An information terminal, comprising: speech detection means for detecting speech of a user; speech recognition means for recognizing a registered word contained in the speech detected by the speech detection means; and control means for performing at least one of the speech recognizing process, the process of managing a schedule by speech, the memo processing by speech, and the notifying process by speech based on the registered word recognized by the speech recognition means, characterized in that the speech recognition means can recognize a registered word contained in the speech detected by the speech detection means in the speech recognition method according to any of claims 1 to 3.

8. A telephone communication terminal which can be connected to a public telephone line network or an Internet communications network, comprising: speech input/output means for inputting and outputting speech; speech recognition means for recognizing input speech; storage means for storing personal information including the name and phone number of a communication partner; screen display means; and control means for controlling each means, characterized in that the speech input/output means has respective and independent input/output systems in the communications unit and the speech recognition unit.

9. A telephone communication terminal which can be connected to a public telephone line network or an Internet communications network, comprising: speech input/output means for inputting and outputting speech; speech recognition means for recognizing input speech; storage means for storing personal information including the name and phone number of a communication partner; screen display means; and control means for controlling each means, characterized in that the storage means separately stores a name vocabulary list of specific names including the name of a person registered in advance; a number vocabulary list of arbitrary phone numbers; a telephone call operation vocabulary list of telephone operations during communications; and a call receiving operation vocabulary list of telephone operations for an incoming call, and all telephone operations relating to an outgoing call, a disconnection, and an incoming call can be performed by the speech recognition means, the storage means, and the control means by input of speech.

10. The telephone communication terminal according to claim 8 or 9, characterized in that a method of recognizing a phone number can also be realized by recognizing a number string pattern formed by a predetermined number of digits or symbols using a number vocabulary list of the storage means and the phone number vocabulary network for recognition of an arbitrary phone number by the speech recognition means by inputting all number of digits of continuous utterance.

11. The telephone communication terminal according to claim 8, characterized in that the screen display means can have an utterance timing display function of announcing an utterance timing.

12. The telephone communication terminal according to claim 8, further comprising second control means for performing at least one of the process of transmitting and receiving mail by speech, the process of managing a schedule by speech, the memo processing by speech, and the notifying process by speech based on the input speech recognized by the speech recognition means.

13. The telephone communication terminal according to claim 8, characterized in that the speech recognition means recognizes a registered word contained in input speech in the speech recognition method according to claim 1.

14. (Cancelled)

15. (Cancelled)
